(19) United States
(12) Patent Application Publication
(10) Pub. No.: US 2025/0129787 A1
(43) Pub. Date: Apr. 24, 2025

(54) PUMP UNIT

(71) Applicant: EBARA CORPORATION, Tokyo (JP)

(72) Inventor: Hiroyuki KAWASAKI, Tokyo (JP)

(21) Appl. No.: 18/834,508

(22) PCT Filed: Dec. 12, 2022
(86) PCT No.: PCT/JP2022/045707

§ 371 Date: Jul. 30, 2024

(30) Foreign Application Priority Data
Feb. 9, 2022 (JP) 2022-018717

(51) Int. Cl. F04D 13/14; F04D 13/06; F04D 29/046; F04D 29/08; F04D 29/42

(52) U.S. Cl. CPC F04D 13/14; F04D 13/06; F04D 29/046; F04D 29/086; F04D 29/42

(57) ABSTRACT

The present invention relates to a pump unit. The pump unit (PU) includes a connector (400) configured to connect a plurality of motor pumps (MP). The connector (400) connects a front-stage side discharge casing (22) and a rear-stage side suction casing (21).

### TECHNICAL FIELD

The present invention relates to a pump unit.

### BACKGROUND ART

A pump apparatus including a moto and a pump coupled by a coupling is known. Such a pump apparatus has a structure that transmits a driving force of the motor to an impeller of the pump via the coupling.

### CITATION LIST

### Patent Literature

Patent document 1: Japanese laid-open patent publication No. 2000-303986

### SUMMARY OF INVENTION

### Technical Problem

However, in such a pump apparatus, since the pump and the motor are arranged side by side, an installation area becomes large. On the other hand, in recent years, the demand for compactness (and energy saving) has increased. As a result, the demand for an integral structure of the pump and the motor has also increased.

A motor pump as the integral structure of the pump and the motor may be incorporated into various apparatuses. In this case, it is desired that the motor pump be made more compact in order to reduce an overall installation area of the apparatus in which the motor pump is incorporated. In particular, depending on a usage environment of the various apparatuses, a pump unit including a plurality of motor pumps may be incorporated into the various apparatuses, but since the installation area of the pump unit is large, it is more desirable to make the pump unit more compact.

Therefore, the present invention provides a pump unit having a compact structure.

### Solution to Problem

In an embodiment, there is provided a pump unit, comprising: a plurality of motor pumps comprising a front-stage side motor pump and a rear-stage side motor pump; and a connector configured to connect the motor pumps, each of the motor pumps comprises: an impeller; a rotor fixed to the impeller; a stator arranged radially outward of the rotor; and a bearing configured to support the impeller, the rotor and the bearing are arranged in a suction side region of the impeller, and the connector is configured to connect a front-stage side discharge casing of the front-stage side motor pump and a rear-stage side suction casing of the rear-stage side motor pump.

In an embodiment, the connector comprises: a first seal member configured to be in close contact with the front-stage side discharge casing; and a second seal member configured to be in close contact with the rear-stage side suction casing.

In an embodiment, the connector comprises a suction casing connector integrally configured with the rear-stage side suction casing, and the suction casing connector comprises a cylindrical attachment portion attached to the front-stage side discharge casing.

In an embodiment, the suction casing connector comprises a seal member configured to be in close contact with the front-stage side discharge casing, and the seal member is attached to an outer surface of the cylindrical attachment portion.

In an embodiment, the suction casing connector comprises a seal member configured to be in close contact with the front-stage side discharge casing, and the seal member is attached to an end surface of the cylindrical attachment portion.

In an embodiment, a pump unit, comprising: a plurality of motor pumps comprising a front-stage side motor pump and a rear-stage side motor pump; and a connector configured to connect the motor pumps, each of the motor pumps comprises: an impeller; a rotor fixed to the impeller; a stator arranged radially outward of the rotor; and a bearing configured to support the impeller, the rotor and the bearing are arranged in a suction side region of the impeller, and the connector comprises an intermediate casing connector that integrally configures a front-stage side discharge casing of the front-stage side motor pump and a rear-stage side suction casing of the rear-stage side motor pump.

In an embodiment, a pump unit, comprising: a plurality of motor pumps comprising a front-stage side motor pump and a rear-stage side motor pump; and a connector configured to connect the motor pumps, each of the motor pumps comprises: an impeller; a rotor fixed to the impeller; a stator arranged radially outward of the rotor; and a bearing configured to support the impeller, the rotor and the bearing are arranged in a suction side region of the impeller, a front-stage side discharge casing of the front-stage side motor pump has an outlet having a first diameter, a rear-stage side suction casing of the rear-stage side motor pump has an inlet having a second diameter different from the first diameter, and the connector comprises: a front-stage side connection portion connected to the outlet; and a rear-stage side connection portion connected to the inlet and having a different size from that of the front-stage side connection portion.

In an embodiment, the connector comprises: a first seal member configured to be in close contact with the front-stage side discharge casing; and a second seal member configured to be in close contact with the rear-stage side suction casing.

In an embodiment, a pump unit, comprising: a plurality of motor pumps comprising a front-stage side motor pump and a rear-stage side motor pump; and a connector configured to connect the motor pumps, each of the motor pumps comprises: an impeller; a rotor fixed to the impeller; a stator arranged radially outward of the rotor; and a bearing configured to support the impeller, the rotor and the bearing are arranged in a suction side region of the impeller, a front-stage side discharge casing of the front-stage side motor pump has a discharge port extending in a direction perpendicular to a direction of a center line of the front-stage side motor pump, and the connector is configured to connect the discharge port and a rear-stage side suction casing of the rear-stage side motor pump.

In an embodiment, the connector comprises: a first seal member configured to be in close contact with the discharge port; and a second seal member configured to be in close contact with the rear-stage suction casing.

In an embodiment, the connector comprises a suction casing connector integrally configured with the rear-stage side suction casing, and the suction casing connector comprises a cylindrical attachment portion attached to the discharge port.

In an embodiment, the connector comprises an intermediate casing connector that integrally configures the discharge port and the rear-stage side suction casing.

In an embodiment, the discharge port has an outlet having a first diameter, the rear-stage side suction casing has an inlet having a second diameter different from the first diameter, and the connector comprises: a front-stage side connection portion connected to the outlet; and a rear-stage side connection portion connected to the inlet and having a different size from that of the front-stage side connection portion.

### Advantageous Effects of Invention

The rotor and the bearing are arranged in the suction side region of the impeller. Therefore, the motor pump can effectively utilize a dead space and, as a result, can have a compact structure. Furthermore, since the pump unit includes a connector having a simple structure, there is no need to connect the motor pumps with each other using a complicated structure. The pump unit including such a connector has a compact structure.

### BRIEF DESCRIPTION OF DRAWINGS

FIG. 1 is a view showing one embodiment of a motor pump;

FIG. 2 is a view showing a flow of a liquid to be handled passing through a gap between a rotary side bearing body and a stationary side bearing body;

FIG. 3 is a view showing an embodiment of a plurality of grooves formed in a flange portion of the stationary side bearing;

FIG. 4A is a view showing an embodiment of a plurality of grooves formed in a cylindrical portion of the stationary side bearing body;

FIG. 4B is a view showing another embodiment of grooves formed in the cylindrical portion of the stationary side bearing body;

FIG. 4C is a view showing another embodiment of grooves formed in the cylindrical portion of the stationary side bearing body;

FIG. 5A is a view showing an embodiment of a thrust load reduction structure provided on a back surface of an impeller;

FIG. 5B is a view of FIG. 5A viewed from an arrow A;

FIG. 6 is a view showing another embodiment of the thrust load reduction structure;

FIG. 7A is a view showing a rotor arranged offset with respect to a stator;

FIG. 7B is a view showing the rotor arranged offset with respect to the stator;

FIG. 8 is a view showing an embodiment of a bearing having a tapered structure;

FIG. 9 is a view showing another embodiment of a bearing having a tapered structure;

FIG. 10 is a view showing a pump unit including a plurality of motor pumps;

FIG. 11 is a view showing another embodiment of the pump unit;

FIG. 12 is a view showing another embodiment of the pump unit;

FIG. 13A is a view showing a motor pump as a comparative example;

FIG. 13B is a view showing another embodiment of the motor pump;

FIG. 13C is a view showing another embodiment of the motor pump;

FIG. 14 is a view showing one embodiment of a method of balancing;

FIG. 15 is a view showing one embodiment of the method of balancing;

FIG. 16 is a view showing one embodiment of the method of balancing;

FIG. 17 is a view showing one embodiment of the method of balancing;

FIG. 18 is a view showing one embodiment of the method of balancing;

FIG. 19 is a view showing another embodiment of the balancing jig;

FIG. 20 is a view showing another embodiment of the method of balancing;

FIG. 21A is a perspective view of another embodiment of the pump unit;

FIG. 21B is a plan view of the pump unit shown in FIG. 21A;

FIG. 22 is a view showing a control flow of the motor pump by a control device;

FIG. 23 is a view showing another embodiment of the impeller;

FIG. 24 is a view showing another embodiment of the impeller;

FIG. 25 is a view showing a seal member arranged between a cover and a side plate;

FIG. 26 is a view showing another embodiment of the impeller;

FIG. 27 is a view showing another embodiment of the motor pump;

FIG. 28 is a view showing another embodiment of the motor pump;

FIG. 29 is a view showing another embodiment of the motor pump;

FIG. 30 is a view showing a motor pump in which various components can be selected depending on operating conditions;

FIG. 31A is a sectional view of a motor pump according to another embodiment;

FIG. 31B is a view of the motor pump shown in FIG. 31A viewed from an axial direction;

FIG. 32A is a cross sectional view of a motor pump according to another embodiment;

FIG. 32B is a front view of a suction casing of the motor pump shown in FIG. 32A;

FIG. 33 is a view showing a pump unit including motor pumps connected in series;

FIG. 34 is a view showing another embodiment of the impeller;

FIG. 35 is a view showing another embodiment of the motor pump;

FIG. 36 is a view showing the side plate provided in the motor pump according to the embodiment described above;

FIG. 37 is a view showing another embodiment of the side plate;

FIG. 38 is a view showing another embodiment of the motor pump;

FIG. 39 is a view showing a seal member attached to a connector;

FIG. 40 is a view showing another embodiment of the pump unit;

FIG. 41 is a view showing another embodiment of the suction casing connector;

FIG. 42 is a view showing another embodiment of the pump unit;

FIG. 43 is a view showing another embodiment of the pump unit;

FIG. 44 is a view showing a seal member attached to the connector;

FIG. 45 is a view showing another embodiment of the pump unit;

FIG. 46 is a view showing another embodiment of the pump unit;

FIG. 47 is a view showing another embodiment of the pump unit;

FIG. 48 is a view showing another embodiment of the pump unit; and

FIG. 49 is a view showing another embodiment of the pump unit.

### DESCRIPTION OF EMBODIMENTS

The following is an embodiment of a motor pump, which will be described with reference to the drawings. In the following embodiments, identical or equivalent components will be marked with the same symbol and redundant explanations will be omitted.

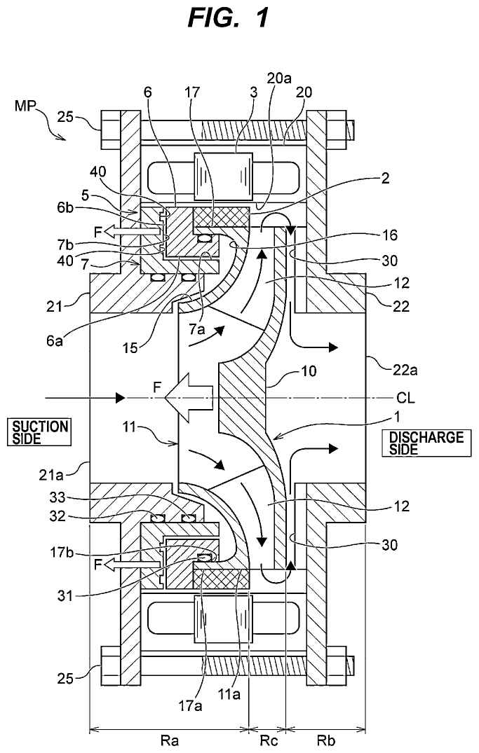

FIG. 1 is a view showing one embodiment of a motor pump. As shown in FIG. 1, a motor pump MP includes an impeller 1, an annular rotor 2 fixed to the impeller 1, a stator 3 arranged radially outward of the rotor 2, and a bearing 5 that supports the impeller 1.

In the embodiment shown in FIG. 1, the motor pump MP is a rotating machine including a permanent magnet type motor, but the type of the motor pump MP is not limited to this embodiment. In one embodiment, the motor pump MP may include an induction type motor or a reluctance type motor. If the motor pump MP includes the permanent magnet type motor, the rotor 2 is a permanent magnet. If the motor pump MP includes the induction motor, the rotor 2 is a squirrel cage rotor.

In the embodiment shown in FIG. 1, the impeller 1 is a centrifugal impeller. More specifically, the impeller 1 includes a disc-shaped main plate 10, a side plate 11 arranged opposite to the main plate 10, and a plurality of vanes 12 arranged between the main plate 10 and the side plates 11. The motor pump MP including the impeller 1 as a centrifugal impeller has excellent lift characteristics and can generate high pressure compared to a pump such as an axial flow pump and a mixed flow pump. Furthermore, the motor pump MP in this embodiment can contribute to a rotational stability of the impeller 1 by utilizing the pressure difference generated inside the motor pump MP.

The side plate 11 includes a suction portion 15 formed in its central portion, and a body portion 16 connected to the suction portion 15. The suction portion 15 extends in a direction of a center line CL of the motor pump MP, and the body portion 16 extends in a direction inclined (more specifically, perpendicular) to the center line CL. The center line CL is parallel to a flow direction of the liquid (liquid to be handled) caused by an operation of the motor pump MP.

As shown in FIG. 1, the side plate 11 includes an annular protrusion 17 extending from an outer edge portion 11a of the side plate 11 (more specifically, an end portion of the body portion 16) toward the suction portion 15. In the embodiment shown in FIG. 1, the body portion 16 and the protrusion 17 are integrally formed, but the protrusion 17 may be a separate member from the body portion 16.

The rotor 2 has an inner diameter larger than an outer diameter of the protrusion 17, and is fixed to an outer circumferential surface 17a of the protrusion 17. The stator 3 is arranged to surround the rotor 2, and is accommodated in a stator casing 20. The stator casing 20 is arranged radially outward of the impeller 1.

The motor pump MP includes a suction casing 21 and a discharge casing 22 arranged on both sides of the stator casing 20. The suction casing 21 is arranged on a suction side of the impeller 1, and the discharge casing 22 is arranged on a discharge side of the impeller 1. The impeller 1, the rotor 2, and the bearing 5 are arranged radially inward of the stator casing 20 and between the suction casing 21 and the discharge casing 22.

The suction casing 21 has an inlet 21a at its central portion. The discharge casing 22 has an outlet 22a in its central portion. The inlet 21a and the outlet 22a are arranged in a straight line along the center line CL. Therefore, the liquid to be handled sucked from the inlet 21a and discharged from the outlet 22a flows in the straight line.

As shown in FIG. 1, an operator inserts a through bolt 25 into the suction casing 21 and the discharge casing 22 with the stator casing 20 sandwiched between the suction casing 21 and the discharge casing 22, and tightens the through bolt 25. Thus, the motor pump MP is assembled.

When the motor pump MP is operated, the liquid to be handled is sucked through the inlet 21a of the suction casing 21 (see a black line arrow in FIG. 1). The impeller 1 pressurizes the liquid to be handled by its rotation, and the liquid to be handled flows inside the impeller 1 in a direction perpendicular (i.e., in a centrifugal direction) to the center line CL. The liquid to be handled discharged to the outside of the impeller 1 collides with an inner circumferential surface 20a of the stator casing 20, and a direction of the liquid to be handled is changed. Thereafter, the liquid to be handled passes through a gap between a back surface of the impeller 1 (more specifically, the main plate 10) and the discharge casing 22, and is discharged from the outlet 22a.

As shown in FIG. 1, the motor pump MP includes a return vane 30 arranged on a back side of the impeller 1. In the embodiment shown in FIG. 1, a plurality of return vanes 30 extending spirally are provided. These return vanes 30 are fixed to the discharge casing 22, and face the main plate 10 of the impeller 1. By providing the return vanes 30, the liquid to be handled discharged from the impeller 1 is smoothly guided to the outlet 22a. The return vanes 30 contribute to the conversion of the liquid to be handled discharged from the impeller 1 from velocity energy to pressure energy.

In the embodiment shown in FIG. 1, the motor pump MP is divided into a suction side region Ra, a discharge side region Rb, and an intermediate region Rc between the suction side region Ra and the discharge side region Rb. The suction side region Ra is a region between the suction casing 21 (more specifically, the inlet 21a of the suction casing 21) and the impeller 1 (more specifically, the side plate 11 of the impeller 1). The discharge side region Rb is a region between the discharge casing 22 (more specifically, the outlet 22a of the discharge casing 22) and the impeller 1 (more specifically, the main plate 10 of the impeller 1). A plurality of vanes 12 are arranged in the intermediate region Rc.

The rotor 2 and the bearing 5 are arranged in the suction side region Ra of the impeller 1. In this embodiment, the impeller 1 includes the side plate 11 having a tapered shape that widens from the suction side region Ra toward the discharge side region Rb. Therefore, a space (dead space) is formed in the suction side region Ra of the impeller 1. According to this embodiment, by arranging the rotor 2 and the bearing 5 in the suction side region Ra, the motor pump MP can have a structure that effectively utilizes the dead space, and as a result, has a compact structure.

The bearing 5 includes a rotary side bearing body 6 attached to the protrusion 17 of the side plate 11 and a stationary side bearing body 7 attached to the suction casing 21. The stationary side bearing body 7 is arranged on the suction side of the rotary side bearing body 6. The rotary side bearing body 6 is a rotating member that rotates with the rotation of the impeller 1, and the stationary side bearing body 7 is a stationary member that does not rotate even when the impeller 1 rotates.

The rotary side bearing body 6 has a cylindrical portion 6a having an outer diameter smaller than an inner diameter of the protrusion 17, and a flange portion 6b projecting outward from the cylindrical portion 6a. Therefore, a cross section of the rotary side bearing body 6 has an L shape. A seal member (e.g., an O ring) 31 is arranged between an inner circumferential surface 17b of the protrusion 17 and the cylindrical portion 6a.

The rotary side bearing body 6 is attached to the protrusion 17 of the impeller 1 with the seal member 31 attached to the cylindrical portion 6a. By mounting the rotary side bearing body 6, the rotor 2 is arranged adjacent to the flange portion 6b of the rotary side bearing body 6.

The stationary side bearing body 7 includes a cylindrical portion 7a arranged opposite to the cylindrical portion 6a of the rotary side bearing body 6, and a flange portion 7b arranged opposite to the flange portion 6b of the rotary side bearing body 6. A cross section of the stationary side bearing body 7 has an L-shape like the cross section of the rotary side bearing body 6. Seal members 32 and 33 are arranged between the cylindrical portion 7a of the stationary side bearing body 7 and the suction casing 21. In this embodiment, two seal members 32 and 33 are arranged, but the number of seal members is not limited to this embodiment.

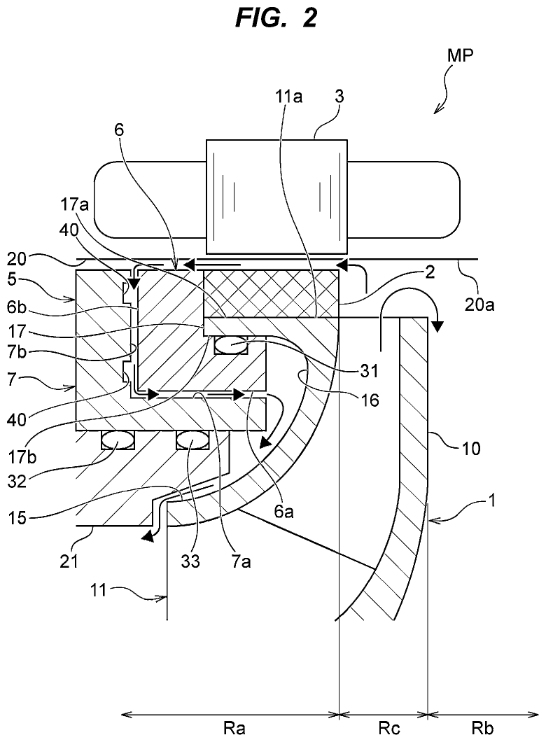

FIG. 2 is a view showing a flow of the liquid to be handled passing through a gap between the rotary side bearing body and the stationary side bearing body. Since a pressure of the liquid to be handled is increased by the rotation of the impeller 1, the pressure of the liquid to be handled in the discharge side region Rb is higher than the pressure of the liquid to be handled in the suction side region Ra. Therefore, a part of the liquid to be handled discharged from the impeller 1 flows back into the suction side region Ra (see the black line arrow in FIG. 2).

More specifically, a part of the liquid to be handled passes through the gap between the stationary casing 20 and the rotor 2, and flows into through the flange portion 6b of the rotary side bearing body 6 and the flange portion 7b of the stationary side bearing body 7.

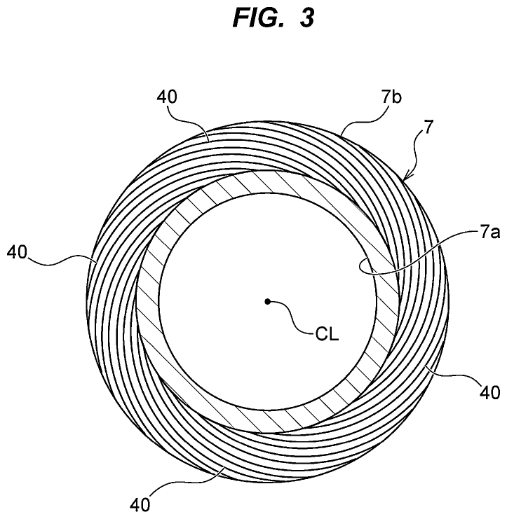

FIG. 3 is a view showing an embodiment of a plurality of grooves formed in the flange portion of the stationary side bearing. As shown in FIG. 3, the stationary side bearing body 7 has a plurality of grooves 40 formed in the flange portion 7b. These grooves 40 are formed on a surface of the flange portion 7b facing the flange portion 6b of the rotary side bearing body 6. The grooves 40 are formed to generate dynamic pressure of the liquid to be handled in the gap between the flange portion 7b and the flange portion 6b. In this embodiment, the grooves 40 are spiral grooves extending spirally. In one embodiment, the grooves 40 may be radial grooves extending radially. By forming the grooves 40, the bearing 5 can support a thrust load of the impeller 1 without contact.

In the embodiment shown in FIG. 3, the grooves 40 are formed in the flange portion 7b, but in one embodiment, the grooves 40 may be formed in the flange portion 6b of the rotary side bearing body 6. With such a configuration, the bearing 5 can also support the thrust load of the impeller 1 without contact.

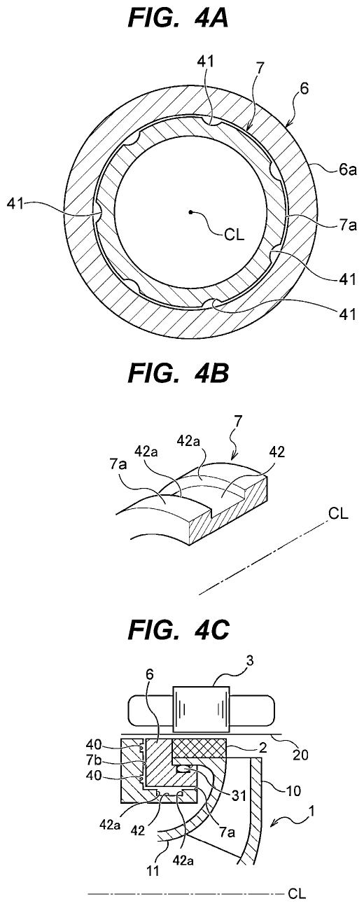

FIG. 4A is a view showing an embodiment of a plurality of grooves formed in the cylindrical portion of the stationary side bearing body. FIG. 4A shows a plurality of grooves 41 when viewed from the direction of the center line CL. The stationary side bearing body 7 may have the grooves 41 formed in the cylindrical portion 7a along the circumferential direction of the cylindrical portion 7a. In the embodiment shown in FIG. 4A, the grooves 41 are arranged at equal intervals, but they may be arranged at uneven intervals.

The grooves 41 are formed on a surface of the cylindrical portion 7a facing the cylindrical portion 6a of the rotary side bearing body 6, and extend parallel to the cylindrical portion 7a (i.e., in the direction of the center line CL). In the embodiment shown in FIG. 4A, each of the grooves 41 has an arcuate concave shape when viewed from the direction of the center line CL. The shapes of the grooves 41 are not limited to this embodiment. In one embodiment, each of the grooves 41 may have a concave shape when viewed from the direction of the center line CL.

FIGS. 4B and 4C are views showing another embodiment of grooves formed in the cylindrical portion of the stationary side bearing body. As shown in FIGS. 4B and 4C, the stationary side bearing body 7 has an annular groove 42 formed in the cylindrical portion 7a along a circumferential direction of the cylindrical portion 7a. The groove 42 is formed in a portion of the cylindrical portion 7a, and has a concave shape when viewed from a direction perpendicular to the direction of the center line CL (see FIGS. 4B and 4C). The cylindrical portions 7a are present at both ends 42a, 42a of the groove 42 in the direction of the center line CL. With such a structure, even if a radial load acts on the impeller 1, the stationary side bearing body 7 (more specifically, the cylindrical portion 7a) can reliably support the impeller 1 via the rotary side bearing body 6. A length of the groove 42 in the direction of the center line CL is not particularly limited. In the embodiment shown in FIGS. 4B and 4C, the stationary side bearing body 7 has a single groove 42, but in one embodiment the stationary side bearing body 7 may have the grooves 42 arranged along the direction of the center line CL.

The liquid to be handled that has passed through the gap between the flange portion 6b and the flange portion 7b flows into the gap between the cylindrical portion 6a and the cylindrical portion 7a. When the rotary side bearing body 6 rotates together with the impeller 1, viscous resistance is generated in the liquid to be handled flowing through this gap. This viscous resistance may have an adverse effect on an operating efficiency of the motor pump MP.

As shown in the embodiment described above, by forming the grooves 41 (or grooves 42), a size of the narrow region formed in the gap between the cylindrical portion 6a and the cylindrical portion 7a is reduced. Therefore, viscous resistance generated in the liquid to be handled can be reduced. Furthermore, by forming the grooves 41 (or grooves 42), dynamic pressure of the liquid to be handled is generated, and the bearing 5 can support a radial load of the impeller 1 without contact. The effect of reducing the viscous resistance by reducing the size of the narrow region formed between the flange portions 6b and 7b can also be achieved by providing the grooves 40 (see FIG. 3).

In the embodiment shown in FIGS. 4A to 4C, the grooves 41 and 42 are formed in the cylindrical portion 7a, but in one embodiment, the grooves 41 and 42 may be formed in the cylindrical portion 6a of the rotary side bearing body 6. With such a configuration as well, the bearing 5 can support the radial load of the impeller 1 without contact.

As shown in FIG. 2, the liquid to be handled that has passed through the gap between the cylindrical portion 6a of the rotary side bearing body 6 and the cylindrical portion 7a of the stationary side bearing body 7 passes through the gap between the side plate 11 of the impeller 1 and the suction casing 21, and returns to the suction side of the motor pump MP. In this embodiment, the bearing 5 is arranged on a path of a leakage flow of the liquid to be handled. With such a configuration, a part of the liquid to be handled flows into the minute gap between the rotary side bearing body 6 and the stationary side bearing body 7, and as a result, the motor pump MP can suppress leakage of the liquid to be handled.

As described above, the pressure of the liquid to be handled in the discharge side region Rb is higher than the pressure of the liquid to be handled in the suction side region Ra. Therefore, a thrust load acts on the impeller 1 from the outlet 22a of the discharge casing 22 toward the inlet 21a of the suction casing 21 (see a white arrow in FIG. 1). The motor pump MP according to this embodiment has a structure that reduces the thrust load.

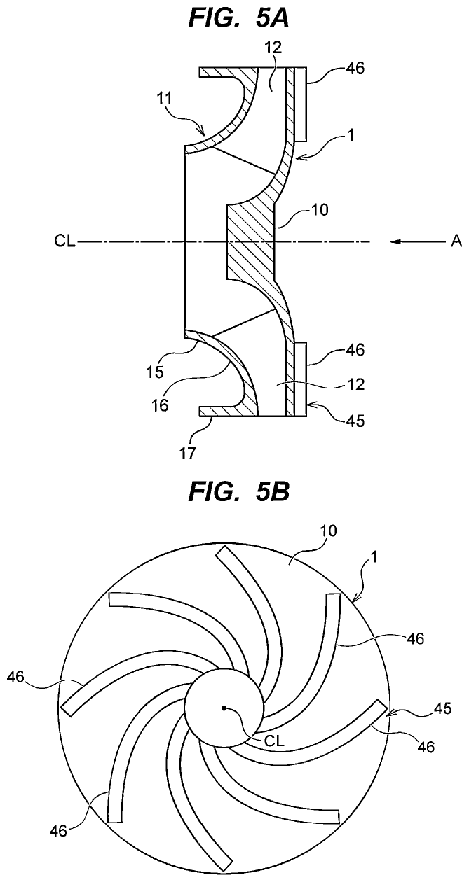

FIG. 5A is a view showing an embodiment of a thrust load reduction structure provided on the back surface of the impeller. FIG. 5B is a view of FIG. 5A viewed from an arrow A. As shown in FIGS. 5A and 5B, the motor pump MP includes a thrust load reduction structure 45 provided on the back surface of the impeller 1 (more specifically, on the main plate 10). In the embodiment shown in FIGS. 5A and 5B, the thrust load reducing structure 45 is a plurality of back vanes 46 extending spirally attached to the main plate 10. The back vanes 46 can generate a load in the direction opposite to the thrust load as the impeller 1 rotates. As a result, the thrust load reduction structure 45 can reduce the thrust load generated in the motor pump MP.

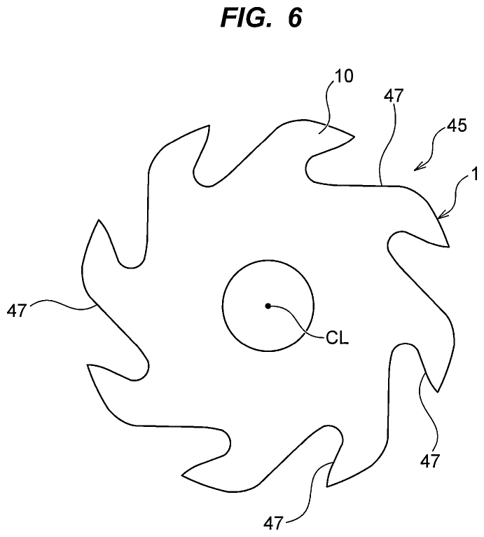

FIG. 6 is a view showing another embodiment of the thrust load reduction structure. As shown in FIG. 6, the thrust load reduction structure 45 may be a plurality of notch structures formed along the circumferential direction of the impeller 1 (more specifically, the main plate 10) and extending toward a center side of the impeller 1. In the embodiment shown in FIG. 6, a plurality of notches 47 are formed in the main plate 10 of the impeller 1. By forming the notches 47, a contact area of the liquid to be handled with the main plate 10 is reduced. As a result, the thrust load reduction structure 45 can reduce the thrust load generated in the motor pump MP. Although not shown, the embodiment shown in FIG. 5 and the embodiment shown in FIG. 6 may be combined.

In this embodiment, the impeller 1 always receives the thrust load from the discharge side toward the suction side. Furthermore, the bearing 5 supports the impeller 1 that generates a rotational force. Therefore, a parallelism of the impeller 1 itself is maintained, and wobbling of the impeller 1 can be suppressed. As a result, the motor pump MP can continue its operation stably with a structure in which only a single bearing 5 is arranged in the suction side region Ra (i.e., a single bearing structure).

In one embodiment, at least one of the impeller 1 and the bearing 5 may be constructed from a lightweight material. An example of the lightweight material includes a resin or a metal with low specific gravity (e.g., aluminum alloys, magnesium alloys, titanium alloys, etc.). With such a structure, a weight of the motor pump MP itself can be reduced, and further, the bearing 5 (and the impeller 1) can be made more compact. The material of the member that come into contact with the liquid (i.e., member in contact with the liquid), such as the impeller 1 and the bearing 5, are not particularly limited, and can be changed to any material as appropriate depending on the quality of the liquid.

Furthermore, in this embodiment, the return vanes 30 (see FIG. 1) can reduce the radial load generated on the impeller 1. The return vanes 30 are arranged at equal intervals along the circumferential direction of the outlet 22a. With such an arrangement, the radial load is evenly distributed, and as a result the radial load generated on the impeller 1 is reduced.

In this embodiment, the motor pump MP includes a permanent magnet type motor. Therefore, when the motor pump MP is started, a constant load acts on the bearing 5 for converting a repulsive force caused by the magnetic force into a rotational force. This load is a force generated on the rotor 2, and the bearing 5 supports this load.

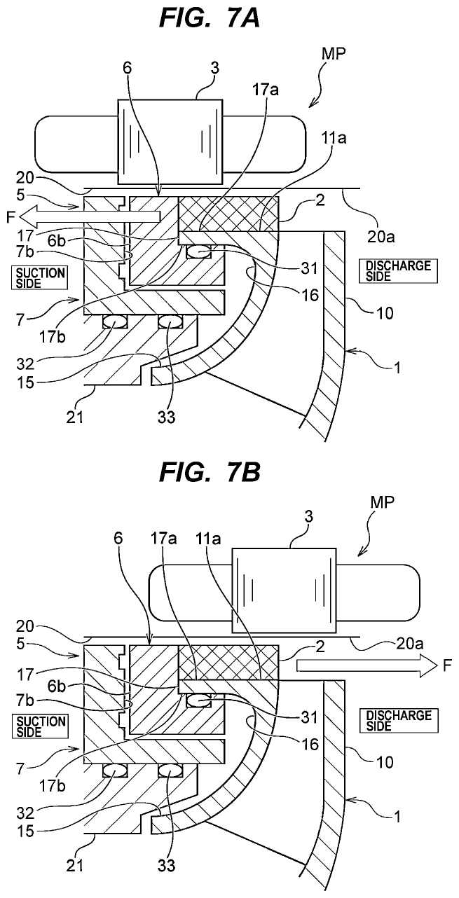

FIGS. 7A and 7B are views showing a rotor arranged offset with respect to a stator. As shown in FIG. 7A, when the rotor 2 is shifted toward the discharge side with respect to the stator 3, the impeller 1 is subjected to a force acting in the direction in which the rotary side bearing body 6 approaches the stationary side bearing body 7 due to the magnetic force generated between the rotor 2 and the stator 3 (see arrow in FIG. 7A). With this arrangement, it is possible to adjust (increase) the thrust load of the rotary side bearing body 6 acting on the stationary side bearing body 7.

As shown in FIG. 7B, when the rotor 2 is shifted toward the suction side with respect to the stator 3, the impeller 1 is subjected to a force acting in the direction in which the rotary side bearing body 6 is separated from the stationary side bearing body 7 due to the magnetic force generated between the rotor 2 and the stator 3 (see FIG. 7B). With this arrangement, it is possible to adjust (decrease) the thrust load of the rotary side bearing body 6 acting on the stationary side bearing body 7.

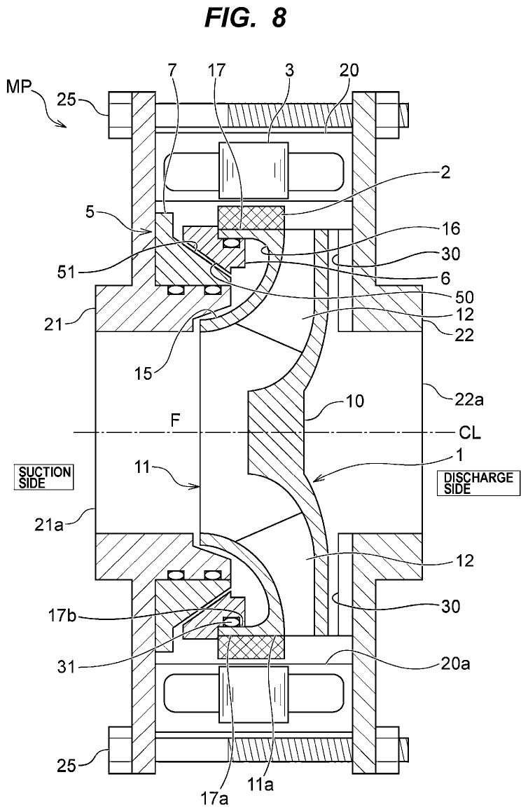

FIG. 8 is a view showing an embodiment of a bearing having a tapered structure. In the embodiment shown in FIG. 8, the bearing 5 has a tapered structure in which the gap between the rotary side bearing body 6 and the stationary side bearing body 7 extends from the suction side to the discharge side in the direction closer to the center line CL (i.e., the central portion of the impeller 1). As shown in FIG. 8, the rotary side bearing body 6 and the stationary side bearing body 7 respectively have inclined surfaces 50 and 51 facing each other. With such a configuration, the bearing 5 can concentrate the radial load and thrust load acting on the rotary side bearing body 6 and the stationary side bearing body 7 on the inclined surfaces 50 and 51, and the bearing 5 has a simple structure.

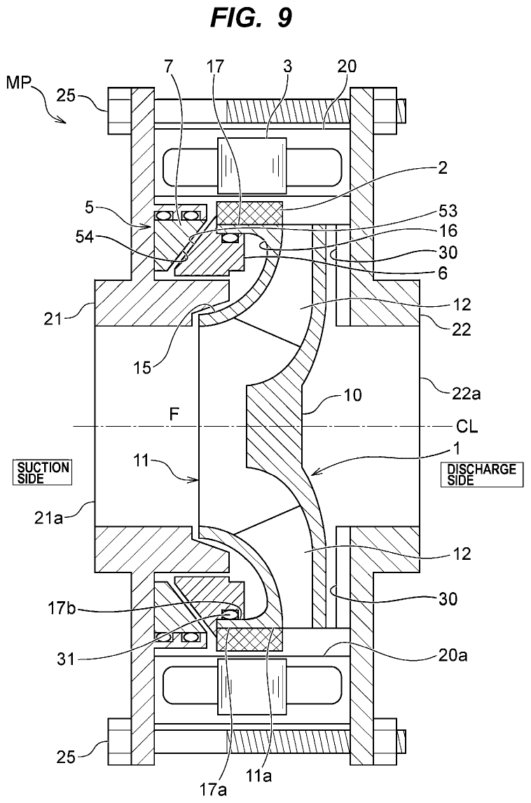

FIG. 9 is a view showing another embodiment of a bearing having a tapered structure. In the embodiment shown in FIG. 9, the bearing 5 has a tapered structure in which the gap between the rotary side bearing body 6 and the stationary side bearing body 7 extends from the suction side to the discharge side in the direction away from the center line CL (i.e., the central portion of the impeller 1). As shown in FIG. 9, the rotary side bearing body 6 and the stationary side bearing body 7 have inclined surfaces 53 and 54, respectively, facing each other.

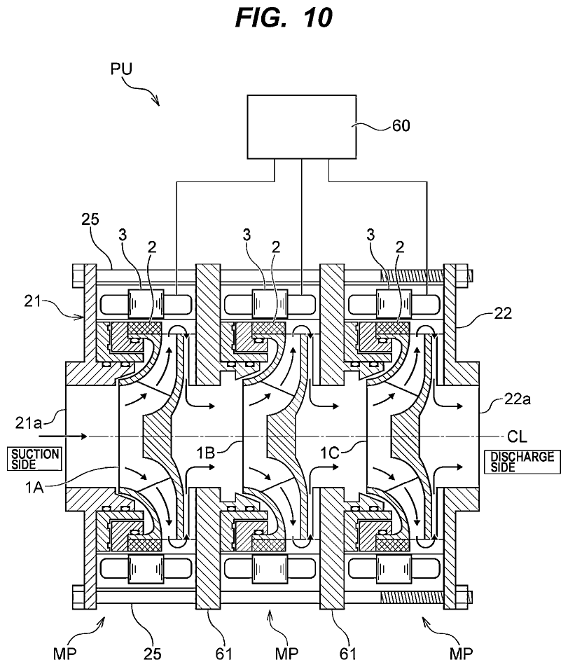

FIG. 10 is a view showing a pump unit including a plurality of motor pumps. As shown in FIG. 10, the pump unit PU may include a plurality of motor pumps MP arranged in series, and an inverter 60 that controls the operation of each of the motor pumps MP. In the embodiment shown in FIG. 10, each of the motor pumps MP has the same structure as that shown in the above described embodiment(s). Therefore, a detailed explanation of the motor pump MP will be omitted.

In the embodiment shown in FIG. 10, the pump unit PU includes three motor pumps MP, but the number of motor pumps MP is not limited to this embodiment. As described above, the inlet 21a and the outlet 22a of the pump unit PU are arranged in a straight line along the center line CL. Therefore, the motor pumps MP can be continuously arranged in a straight line, and the pump unit PU can easily have a multi-stage motor pump structure.

As shown in FIG. 10, two intermediate casings 61 are arranged between the suction casing 21, arranged adjacent to the first-stage impeller 1A, and the discharge casing 22 arranged adjacent to the third-stage impeller 1C. The second-stage impeller 1B is arranged between these intermediate casings 61, 61. Each of the intermediate casings 61, 61 has a common (i.e., similar) structure to the suction casing 21. An operator can assemble the pump unit by inserting and tightening the through bolt 25 into the suction casing 21, the intermediate casings 61, 61, and the discharge casing 22 with the intermediate casings 61, 61 sandwiched between the suction casing 21 and discharge casing 22.

As shown in FIG. 10, one inverter 60 is connected to the stators 3 of the motor pumps MP. The inverter 60 can independently control each of the motor pumps MP. Therefore, the operator can operate at least one motor pump MP at any timing depending on the operating conditions of the pump unit.

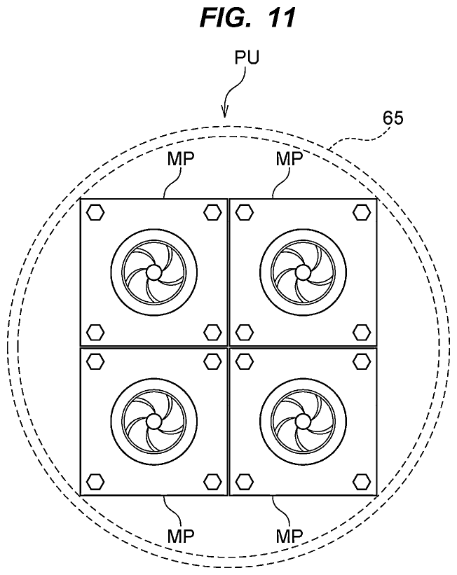

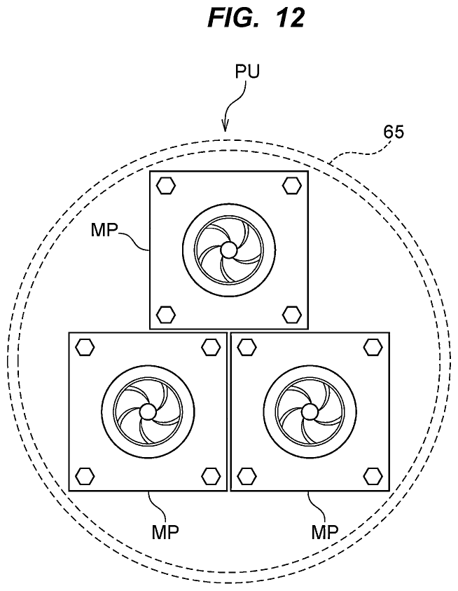

FIGS. 11 and 12 are views showing another embodiment of the pump unit. In the embodiment shown in FIGS. 11 and 12, the pump unit PU includes a plurality of motor pumps MP arranged in parallel. In FIG. 11, although it is simply drawn, each of the motor pumps MP is installed inside a pipe 65. Although four motor pumps MP are provided in FIG. 11, the number of motor pumps MP is not limited to this embodiment. As shown in FIG. 12, three motor pumps MP may be provided.

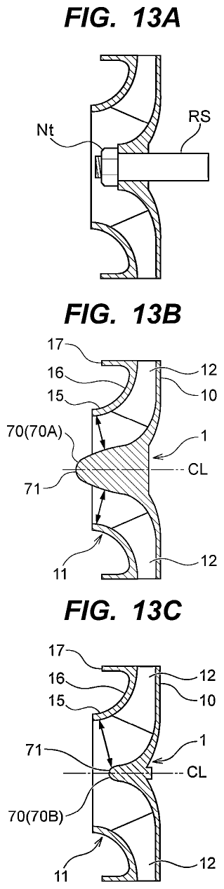

FIG. 13A is a view showing a motor pump as a comparative example. FIGS. 13B and 13C are views showing another embodiment of the motor pump. As shown in FIG. 13A, the motor pump as a comparative example includes a rotary shaft RS, but the motor pump MP according to the embodiment does not have the rotary shaft RS. Instead, the impeller 1 includes a rounded convex portion 70 arranged at its central portion.

In the embodiment shown in FIG. 13B, the impeller 1 has a convex portion 70A having a first radius of curvature, and in the embodiment shown in FIG. 13C, the impeller 1 has a convex portion 70B having a second radius of curvature. Hereinafter, the convex portions 70A and 70B may be simply referred to as the convex portion 70 without distinguishing between them.

The convex portion 70 is arranged at the center of the main plate 10, and is integrally formed with the main plate 10. In one embodiment, the convex portion 70 may be a different member from the main plate 10. In this case, the convex portions 70 having different radius of curvature may be replaced depending on the operating conditions of the motor pump.

A tip potion 71 of the convex portion 70 has a smooth convex shape, and the liquid to be handled flowing into the impeller 1 comes into contact with the tip portion 71 of the convex portion 70. By providing the convex portion 70, the liquid to be handled is smoothly and efficiently guided to the vane 12 without its flow being obstructed. On the other hand, in the motor pump as a comparative example, the rotary shaft RS is fixed to an impeller by a nut Nt. Therefore, the flow of the liquid to be handled may be obstructed by the nut Nt (and the rotary shaft RS).

The convex portion 70A shown in FIG. 13B has a radius of curvature larger than that of the convex portion 70B shown in FIG. 13C. By increasing the radius of curvature of the convex portion 70, a distance between the convex portion 70 and the side plate 11 becomes smaller. Conversely, by decreasing the radius of curvature of the convex portion 70, the distance between the convex portion 70 and the side plate 11 increases. In this manner, by changing the radius of curvature of the convex portion 70, a size of the flow path of the impeller 1 for liquid to be handled can be adjusted. The flow path of the impeller 1 shown in FIG. 13C is larger than the flow path of the impeller 1 shown in FIG. 13B.

According to this embodiment, since the motor pump MP does not have a rotary shaft, the number of parts can be reduced and the size of the flow path can be adjusted. Furthermore, since there is no need to provide a rotary shaft, the impeller 1 can have a compact size. As a result, an entire motor pump MP can have a compact size.

The motor pump rotates the impeller 1 at high speed by its operation. If a center of gravity of the impeller 1 is shifted, the impeller 1 rotates at high speed in an eccentric state. As a result, noise may be generated, and in the worst case, the motor pump may break down.

Therefore, the operator performs a method of balancing (dynamic balance) to determine the center of gravity of the impeller 1 to a desire position. As shown in FIG. 13A, when the rotary shaft RS is attached to the impeller, it is necessary to attach the rotary shaft RS to a test machine and rotate the impeller together with the rotary shaft RS. In this embodiment, since the rotary shaft RS is not attached to the impeller 1, the operator can perform the method of balancing (i.e., balance adjustment method) described below.

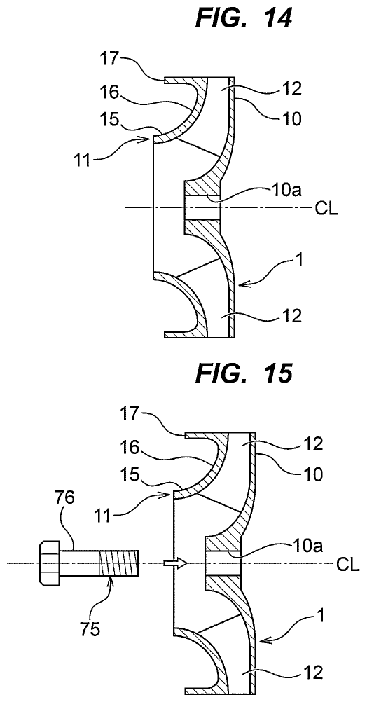

FIGS. 14 to 18 are views showing one embodiment of the method of balancing. As shown in FIG. 14, the operator first performs a process of forming a through hole 10a in the center of the impeller 1 (more specifically, in the main plate 10). After that, as shown in FIG. 15, the operator inserts a shaft body 76 of a balancing jig 75 into the through hole 10a. The shaft body 76 of the balancing jig 75 corresponds to a rotary shaft.

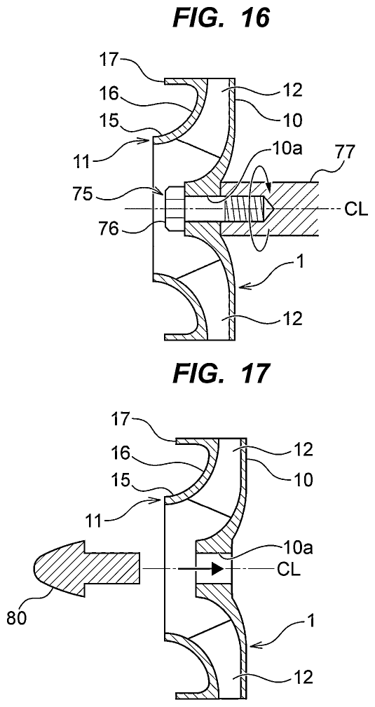

After that, as shown in FIG. 16, the operator places a fixed body 77 on the back side of the impeller 1, and fastens the shaft body 76 to the fixed body 77. In this state, the operator rotates the impeller 1 together with the balancing jig 75, determines the center of gravity of the impeller 1, and performs a process of adjusting the center of gravity. In this manner, the balancing jig 75 has a structure that supports the center of the impeller 1. Therefore, the balancing jig 75 may be referred to as a center support adjustment jig.

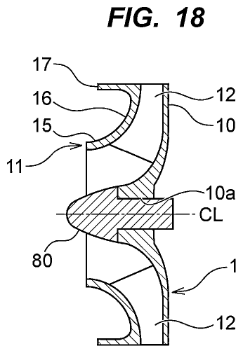

After determining the center of gravity of the impeller 1 at the desired position, the operator pulls out the shaft body 76 of the balancing jig 75, and then inserts a center cap 80 into the through hole 10a to close the through hole 10a. (See FIGS. 17 and 18). The center cap 80 has a rounded shape similar to the convex portion 70 according to the embodiment shown in FIGS. 13B and 13C. Therefore, the liquid to be handled is smoothly and efficiently guided to the vane 12 without its flow being obstructed.

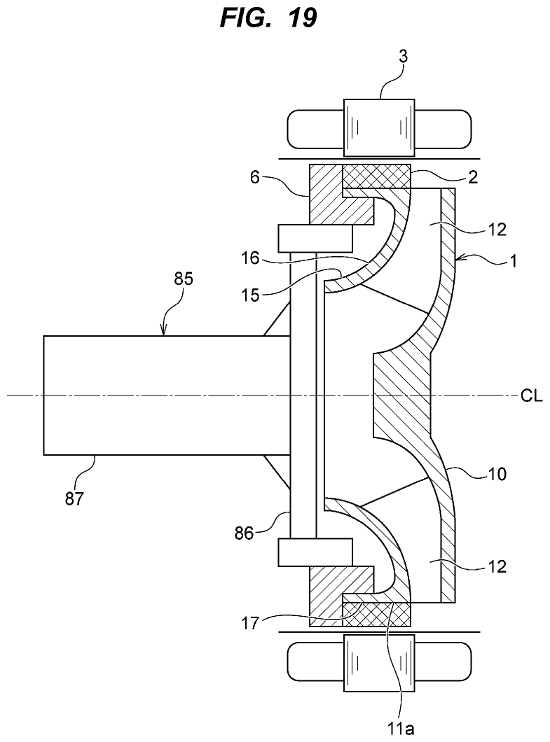

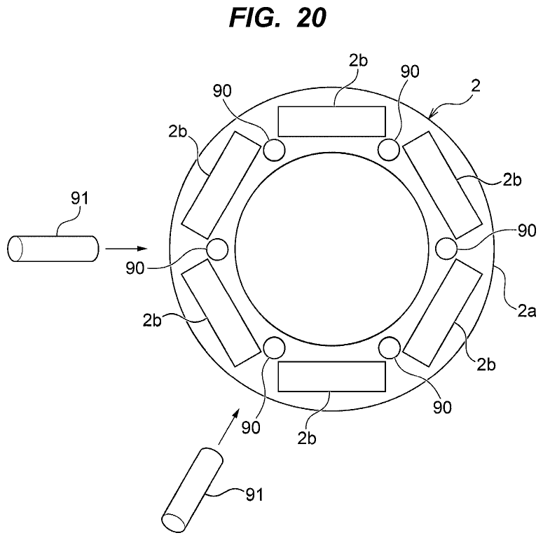

FIG. 19 is a view showing another embodiment of the balancing jig. In the embodiment shown in FIG. 18, the balancing jig 75 has a structure that supports the center of the impeller 1. In the embodiment shown in FIG. 19, the balancing jig 85 includes a supporter 86 that supports the rotary side bearing body 6 of the bearing 5, and a shaft portion 87 fixed to the supporter 86. In this manner, the balancing jig 85 has a structure for supporting an end portion of the impeller 1. Therefore, the balancing jig 85 may be referred to as an edge support adjustment jig.

The supporter 86 has an annular shape having an outer diameter smaller than the inner diameter of the rotary side bearing body 6, and by inserting the supporter 86 into the rotary side bearing body 6, the balancing jig 85 supports to the impeller 1 via the rotary side bearing body 6. In this state, the operator performs a process of rotating the impeller 1 together with the balancing jig 85. Thereafter, the operator determines the center of gravity of the impeller 1 while rotating the impeller 1, and performs a process of adjusting the center of gravity.

According to the embodiment shown in FIG. 19, the operator does not need to form the through hole 10a. Also in the embodiment shown in FIG. 19, the impeller 1 may have the convex portion 70 formed at its center position (see FIGS. 13A and 13B).

FIG. 20 is a view showing another embodiment of the method of balancing. As shown in FIG. 20, the rotor 2 includes an annular iron core 2a, and a plurality of magnets 2b embedded in the iron core 2a. The magnets 2b are arranged at equal intervals along a circumferential direction of the rotor 2 (more specifically, the iron core 2a). The operator performs a process of forming a plurality of weight insertion holes 90 along the circumferential direction of the rotor 2. The process of forming the weight insertion hole 90 is performed when manufacturing of the iron core 2a.

The weight insertion hole 90 is formed between the magnets 2b adjacent to each other. The operator performs the process of determining the center of gravity of the impeller 1 to determine the current center of gravity of the impeller 1. If the center of gravity of the impeller 1 is shifted, the operator inserts a weight 91 into at least one of the weight insertion holes 90 to adjust the center of gravity.

In one embodiment, when the center of gravity of the impeller 1 is shifted, instead of inserting the weight 91 into the weight insertion hole 90, the operator may remove any excess weight that may cause a shift in the center of gravity of the impeller 1.

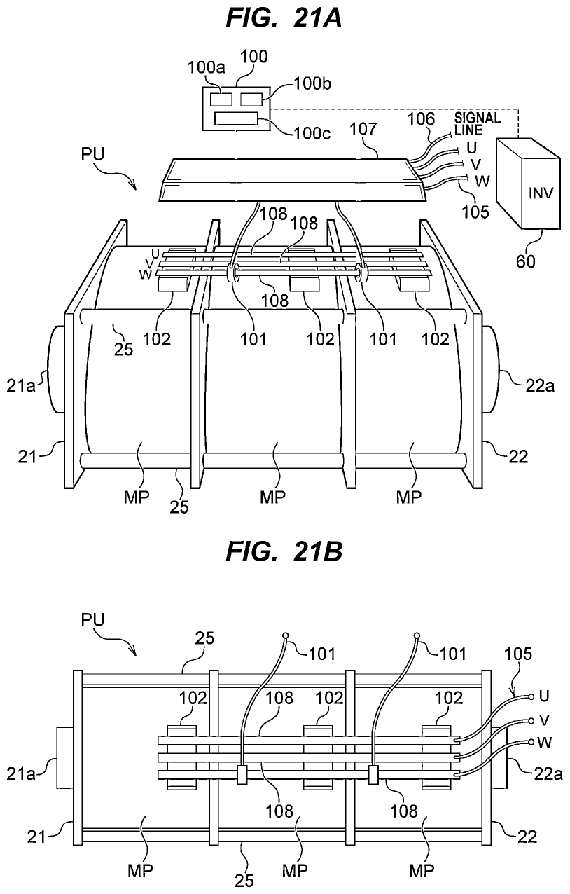

FIG. 21A is a perspective view of another embodiment of the pump unit. FIG. 21B is a plan view of the pump unit shown in FIG. 21A. As shown in FIGS. 21A and 21B, the pump unit PU includes a plurality of (in this embodiment, three) motor pumps MP, a control device 100 that operates the motor pumps MP at variable speeds, and a current sensor 101 that is electrically connected to the control device and detects the current supplied to the motor pumps MP.

In the embodiment, two current sensors 101 are arranged, but at least one current sensor 101 may be arranged. Examples of the current sensor 101 include a hall element and a CT (current converter).

The pump unit PU includes a power line 105 and a signal line 106 extending from the motor pumps MP, and a protective cover 107 that protects the current sensor 101, the power line 105, and the signal line 106. The power line 105 and the signal line 106 are electrically connected to the inverter 60.

Copper bars (in other words, current plate, copper plate) 108 having a U-phase, a V-phase, and a W-phase are stretched between the motor pumps MP, and the current sensor 101 is connected to one of copper bars 108. Each of the motor pumps MP includes a terminal block 102, and the copper bar 108 is connected to the terminal block 102.

The control device 100 is electrically connected to the inverter 60, and configured to control the operation of motor pump MP via the inverter 60. The control device 100 may be arranged outside the inverter 60 or inside the inverter 60.

The control device 100 includes a signal receiver 100a that receives a signal from the current sensor 101 through the signal line 106, a memory 100b that stores information regarding the operation of the motor pump MP and an operation program, and a controller 100c controls the operation of the motor pump MP based on data received at the signal receiver and data stored in the memory.

In this embodiment, the pump unit PU includes one inverter 60 for the motor pumps MP. The pump unit PU may include a number of inverters 60 corresponding to the number of motor pumps MP. When the motor pumps MP are arranged, each of the inverters 60 controls the operation of each of the motor pumps MP by the control device 100.

As described above, the motor pump MP has a compact structure that makes effective use of dead space. Therefore, by connecting these motor pumps MP in series, the pump unit PU can be operated at a pump head without increasing its installation area.

The motor pump MP is the rotating machine with the permanent magnet type motor. Such motor rotates uncontrolled by forcibly applying a voltage at start up. The control of the rotational speed of the motor pump MP by the inverter 60 is started immediately, and then a steady operation of motor pump MP is started.

In this embodiment, the pump unit PU includes the motor pumps MP. Therefore, there is no problem if a difference in rotational speed between the motor pumps MP is eliminated before starting control of the rotational speed of the motor pump MP. However, if the difference in rotational speed is not resolved, there may be a startup failure of the motor pump MP.

Generally, when the number of magnetic poles of the rotor 2 increases, the motor pump MP rotates smoothly, and the difference in rotational speed between the motor pumps MP tends to be eliminated. The motor pump MP in the embodiment has a structure in which a flow path is formed inside the rotor 2, and the outer diameter of the rotor 2 is designed to be large.

When the outer diameter of the rotor 2 is large, a size of the rotor 2 in an outer peripheral direction becomes large, so that a plurality of magnets can be easily arranged and the number of magnetic poles can be increased. With such a configuration, the pump unit PU can eliminate the difference in rotational speed among the motor pumps MP. Furthermore, in this embodiment, by using inexpensive planar magnets, the cost of the rotor 2 can be reduced compared to a general motor using curved magnets.

Furthermore, in this embodiment, the motor pump MP has a canned motor structure in which the stator 3 is accommodated in the stator casing 20, and the distance between the rotor 2 and the stator 3 is generally larger than that of the motor. Therefore, the motor pump MP can reduce torque ripple, which means a range of torque fluctuations, and as a result, the pump unit PU can eliminate the difference in rotational speed among the motor pumps MP.

In this manner, the pump unit PU can eliminate the difference in rotational speed, but it is desirable to operate the motor pump MP more stably during the startup and/or the steady operation of the motor pump MP.

Therefore, a method of controlling the motor pump MP will be described below. In the embodiment, the motor pumps MP are connected in series. In this case, if the liquid to be handled contains foreign matter, the foreign matter may become entangled with the motor pump MP (especially the first motor pump MP), and as a result, the operation of the pump unit PU may be hindered by the foreign matter. Furthermore, for some reason, there is a possibility that the difference in rotational speed between the motor pumps MP will not be resolved.

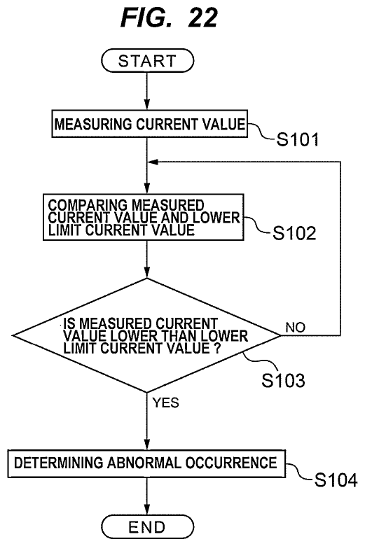

FIG. 22 is a view showing a control flow of the motor pump by the control device. As shown in step S101 in FIG. 22, the control device 100 electrically connected to the inverter 60 determines the current values of the motor pumps MP during the current operation of the motor pumps MP based on the output current of the inverter 60 (more specifically, a total current value of each of motor pumps MP).

The control device 100 then calculates a lower current limit value based on an assumed current value during a normal operation of the motor pump MP (more specifically, during the startup and the steady operation), and compares a total measured current value (measured current value Amax) with a predetermined lower current limit value (see step S102). In one embodiment, the memory 100b of the control device 100 stores the assumed current values for each motor pump MP and the assumed current values for the motor pumps MP. The memory 100b may calculate the assumed current values of each motor pump MP from the assumed current values of each motor pump MP.

The control device 100 may determine “the assumed current value expected during normal operation” based on at least one of a rated current value and an allowable current value of each motor pump MP, or determine “the assumed current value expected during normal operation” based on the current value when operating the motor pump MP.

In one embodiment, the control device 100 determines the lower limit current value based on the number of motor pumps MP. For example, the lower limit current value is determined by the following formula.

The lower limit current value=the assumed current value of the motor pumps MP×(1−1/the number of motor pumps n).

In this embodiment, since three motor pumps MP are arranged, the lower limit current value is ⅔ of the assumed current value.

After step S102, the control device 100 compares the calculated lower limit current value and the measured current value (see step S103). More specifically, the control device 100 determines whether or not the measured current value is lower than the lower limit current value (measured current value Amax>lower limit current value).

If the measured current value is lower than the lower limit current value (see “YES” in step S103), in this embodiment, in a case in which the measured current value is less than ⅔ of the assumed current value (i.e., the lower limit current value), the control device 100 determines that at least one of the motor pumps MP is abnormal (see step S104). If the measured current value has not decreased below the lower limit current value (see “NO” in step S103), the control device 100 repeats steps S102 and S103.

When the control device 100 determines the abnormal occurrence, the control device 100 may issue an alarm while continuing to operate the motor pump MP, or may stop the operation of the motor pump MP and issue the alarm.

Such a control flow may be performed at the time of starting the motor pump MP, or may be performed during the steady operation of the motor pump MP. When performing the control flow at the time of starting the motor pump MP, the measured current value corresponds to a starting current value at the time of starting the motor pumps MP, and the assumed current value is a current value expected during normal startup of the motor pumps MP.

When performing the control flow during the steady operation of the motor pump MP, the measured current value corresponds to an operating current value during the steady operation of the motor pumps MP, and the assumed current value is the current value expected during the normal steady operation of the motor pumps MP.

The starting current value and the operating current value may be the same or different. Similarly, the assumed current value assumed during normal start up and the assumed current value assumed during the normal steady operation may be the same or different.

In one embodiment, the control device 100 may determine the assumed current value based on the flow rates on the discharge sides of the motor pumps MP. In this case, the pump unit PU includes a flow rate sensor (not shown) that detects the flow rate of the liquid to be handled, and the flow rate sensor is electrically connected to the control device 100.

The memory 100b of the control device 100 stores data indicating a correlation between the flow rate of the liquid to be handled during normal operation and the current supplied to the motor pumps MP during normal operation. The control device 100 determines the assumed current value based on this data, and calculates the lower limit current value based on the determined assumed current value. The above formula can be used as an example of the calculation formula for the lower limit current value.

The control device 100 compares the measured current value during the steady operation of the motor pumps MP with the lower limit current value, and when the measured current value is lower than the lower limit current value, it is determined that at least one of the motor pump MP has an abnormality.

In one embodiment, the control device 100 may determine the assumed current value based on the pressure on the discharge side of the motor pumps MP. In this case, the pump unit PU includes a pressure sensor (not shown) that detects the pressure of the liquid to be handled, and the pressure sensor is electrically connected to the control device 100.

The memory 100b of the control device 100 stores data indicating the correlation between the pressure of the liquid to be handled and the current supplied to the motor pumps MP during normal operation. The control device 100 determines the assumed current value based on this data, and calculates the lower limit current value based on the determined assumed current value. The above formula can be used as an example of the calculation formula for the lower limit current value.

The control device 100 compares the measured current value during the steady operation of the motor pumps MP with the lower limit current value, and when the measured current value is lower than the lower limit current value, it is determined that at least one of the motor pumps MP has an abnormality.

In the embodiment shown in FIGS. 21A and 21B, the pump unit PU includes the current sensor 101 (first current sensor 101) arranged between the first motor pump MP and the second motor pump MP, and the current sensor 101 (second current sensor 101) arranged between the second motor pump MP and the third motor pump MP.

Therefore, the control device 100 measures the current value (i.e., the measured current value Aa1) of the first motor pump MP based on the signal sent from the first current sensor 101, and measures a sum (i.e., the measured current value Ab (=Aa1+Aa2)) of the measured current value Aa1 of the first motor pump MP and the measured current value Aa2 of the second motor pump MP based on the signal sent from the second current sensor 101.

The control device 100 compares the measured current value Aa1 with the assumed current value assumed during normal operation (during the startup and the steady operation) of each motor pump MP, and if the measured current value Aa1 is lower than the assumed current value (Aa1<assumed current value), the control device 100 determines that an error has occurred in the first motor pump MP.

The control device 100 compares the measured current value Aa1 with the assumed current value assumed during normal operation of each motor pump MP (during the startup and the steady operation), if the measured current value Aa1 is larger than the assumed current value (Aa1>assumed current value), and a value (i.e., Ab−Aa1) obtained by subtracting the measured current value Aa1 from the measured current value Ab is smaller than the assumed current value ((Ab−Aa1)<assumed current value), the control device 100 determines that an abnormality has occurred in the second motor pump MP. The value obtained by subtracting the measured current value Aa1 from the measured current value Ab corresponds to the measured current value Aa2.

When the control device 100 determines that the measured current value Amax is lower than the lower limit current value, and determines that there is no abnormality in the first motor pump MP and the second motor pump MP, the control device 100 determines that the third motor pump MP has an abnormality.

When the pump unit PU includes four motor pumps MP connected in series, the pump unit PU includes the current sensor 101 (third current sensor 101) arranged between the third motor pump MP and the fourth motor pump MP.

The control device 100 determines a sum (i.e., the measured current value Ac) of the measured current value Aa1 of the first motor pump MP, the measured current value Aa2 of the second motor pump MP, and the measured current value Aa3 of the third motor pump MP based on the signal sent from the third current sensor 101.

If the measured current value Aa1 is larger than the assumed current value (Aa1>assumed current value), the value obtained by subtracting the measured current value Aa1 from the measured current value Ab (i.e., Ab−Aa1) is larger than the assumed current value ((Ab−Aa1)>assumed current value), and the value obtained by subtracting the measured current value Ab from the measured current value Ac (i.e., Ac−Ab, where Ab=Aa1+Aa2) is lower than the assumed current value, the control device 100 determines that an abnormality has occurred in the third motor pump MP. The value obtained by subtracting the measured current value Ab from the measured current value Ac corresponds to the assumed current value Aa3.

When the control device 100 determines that the measured current value Amax is lower than the lower limit current value, and determines that no abnormality has occurred in the first motor pump MP, the second motor pump MP, and the third motor pump MP, the control device 100 determines that an abnormality has occurred in the fourth motor pump MP. When the pump unit PU includes five or more motor pumps MP connected in series, the control device 100 can determine the abnormality of each motor pump MP using the same method as described above.

In the above described embodiment, a method of controlling the motor pumps MP connected in series has been described, but the pump unit PU may control the motor pumps MP connected in parallel. When controlling the motor pumps MP (see FIGS. 11 and 12) connected in parallel, the control device 100 may be configured to shift a startup timing of each of the motor pumps MP.

By shifting the startup timing, the pump unit PU can form a swirling flow in the pipe 65. By forming the swirling flow, foreign matter and air adhering to the pipe 65 can be removed, and furthermore, the liquid to be handled can be prevented from stagnation.

In order to form the swirling flow, the control device 100 starts one (the first motor pump MP) of the motor pumps MP, and then may start the motor pump MP (the second motor pump MP) adjacent to the started motor pump MP (i.e., the first motor pump MP). In this manner, by sequentially starting the adjacent motor pumps MP, the pump unit PU can form the swirling flow that swirls in an order in which the motor pumps MP are started.

For example, when three motor pumps MP are arranged, the control device 100 may start the first motor pump MP, then start the second motor pump MP, or after starting the third motor pump MP, the control device 100 may start the first motor pump MP adjacent to the third motor pump MP.

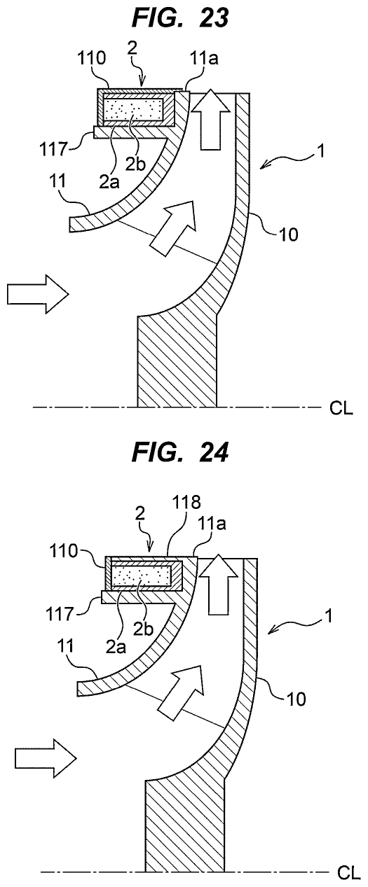

FIG. 23 is a view showing another embodiment of the impeller. In this embodiment, illustration of the bearing 5 is omitted. In the embodiment described above, the impeller 1 includes the annular protrusion 17 extending from the outer edge portion 11a of the side plate 11 toward the suction portion 15 (see FIG. 1). In the embodiment shown in FIG. 23, the side plate 11 of the impeller 1 has an annular protrusion 117 arranged radially inward of the outer edge portion 11a of the side plate 11.

The rotor 2 is arranged on an annular step formed between the outer edge portion 11a of the side plate 11 and the protrusion 117, and an exposed portion of the rotor 2 is covered with a cover 110. The cover 110 is one of the components of the motor pump MP. Examples of the cover 110 include a corrosion-resistant can, a resin coat, or a Ni plating coat.

In one embodiment, the iron core 2a of the rotor 2 is joined to the protrusion 117 by adhesive, press fit, shrink fit, welding, or the like. Similarly, the cover 110 is joined to the impeller 1 by adhesive, press fitting, shrink fitting, welding, or the like.

FIG. 24 is a view showing another embodiment of the impeller. In this embodiment, illustration of the bearing 5 is omitted. As shown in FIG. 24, the impeller 1 may include an annular mounting portion 118 arranged radially outward from the protrusion 117. By inserting the rotor 2 into an annular space between the mounting portion 118 and the protrusion 117, the rotor 2 can be fixed to the side plate 11 more reliably. Also in this embodiment, the exposed portion of the rotor 2 is covered with the cover 110.

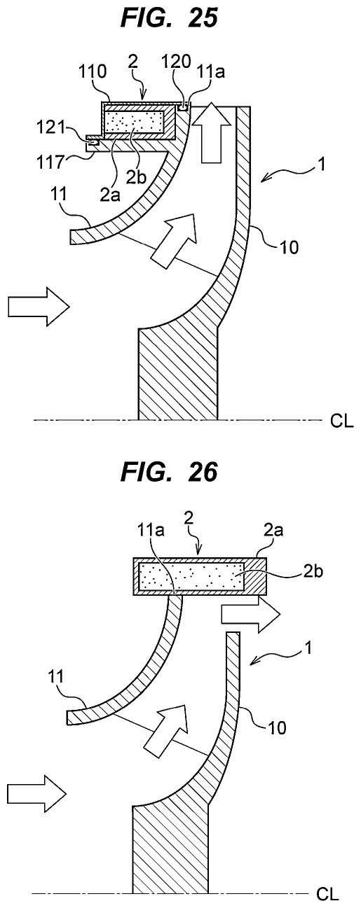

FIG. 25 is a view showing a seal member arranged between the cover and the side plate. In this embodiment, illustration of the bearing 5 is omitted. As shown in FIG. 25, by arranging seal members (e.g., O rings) 120, 121 between the cover 110 and the side plate 11 (more specifically, the outer edge portion 11a and the protrusion 117 of the side plate 11), the liquid can be reliably prevented from coming into contact with the rotor 2.

The impeller 1 according to the embodiment shown in FIGS. 1 to 25 is manufactured by, for example, casting, stainless steel press molding, resin molding, or the like. The impeller 1 according to the embodiment shown in FIGS. 26 to 34 described below may also be manufactured by casting, stainless steel press molding, resin molding, or the like.

FIG. 26 is a view showing another embodiment of the impeller. In this embodiment, illustration of the bearing 5 is omitted. As shown in FIG. 26, the rotor 2 is fixed to the outer edge portion 11a of the side plate 11 so as to block the flow path (i.e., an outlet flow path) of the impeller 1 formed between the main plate 10 and the side plate 11. Also in this embodiment, the rotor 2 is arranged in the suction side region Ra.

In the embodiment shown in FIG. 26, the rotor 2 is not covered with the cover 110, and the rotor 2 is made of a corrosion-resistant material. Also in the embodiment described above, the rotor 2 does not necessarily need to be covered with the cover 110, and may be made of a corrosion-resistant material. In one embodiment, the rotor 2 may be covered with the cover 110.

With this configuration, the liquid to be handled passing through the outlet flow path collides with an inner circumferential surface of the rotor 2, and a direction of the liquid to be handled is changed. Thereafter, the liquid to be handled passes through a gap between the main plate 10 and the discharge casing 22, and is discharged from the outlet 22a.

Also in the embodiment shown in FIGS. 23 to 26, the rotor 2 and the bearing 5 are arranged in the suction side region Ra of the impeller 1, so the motor pump MP has a compact structure.

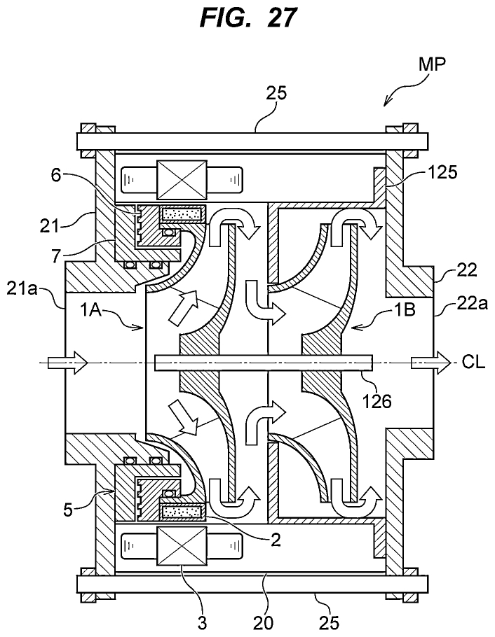

FIG. 27 is a view showing another embodiment of the motor pump. As shown in FIG. 27, the motor pump MP includes a first impeller 1A arranged on the inlet 21a side, a second impeller 1B arranged on the outlet 22a side, and a communication shaft 126 connected to the first impeller 1A and the second impeller 1B. The rotor 2 is fixed to the first impeller 1A, and the stator 3 is arranged radially outward the rotor 2. The bearing 5 supports the first impeller 1A, and the second impeller 1B is supported by the bearing 5 via the communication shaft 126.

In the embodiment shown in FIG. 27, the motor pump MP includes an intermediate casing 125 arranged between the first impeller 1A and the second impeller 1B. The intermediate casing 125 is an annular partition wall that separates the discharge side of the first impeller 1A from the suction side of the second impeller 1B. In this embodiment, the intermediate casing 125 is fixed to the stator casing 20.

In the embodiment shown in FIG. 27, the motor pump MP includes two impellers 1, but the number of impellers 1 is not limited to this embodiment. The motor pump MP may include a plurality of intermediate casings 125 depending on the number of impellers 1. In other words, the motor pump MP may include a plurality of impellers 1 including at least the first impeller 1A and the second impeller 1B.

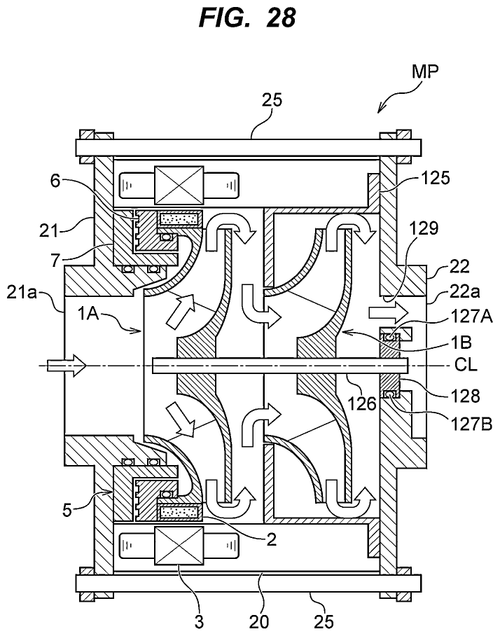

FIG. 28 is a view showing another embodiment of the motor pump. As shown in FIG. 28, the motor pump MP further includes a discharge side bearing 128 that rotatably supports the communication shaft 126. The discharge side bearing 128 is arranged on the discharge side of the second impeller 1B. The discharge side bearing 128 is attached to the discharge casing 22, and seal members (e.g., O rings) 127A, 127B are arranged in the gap between the discharge side bearing 128 and the discharge casing 22. Although the motor pump MP includes two impellers 1 also in the embodiment shown in FIG. 28, the number of impellers 1 is not limited to this embodiment. The motor pump MP may include a plurality of impellers 1 including at least the first impeller 1A and the second impeller 1B.

As shown in FIG. 28, the discharge casing 22 has a flow path 129 communicating with the outlet 22a. The flow path 129 is arranged radially outward of the communication shaft 126. The liquid to be handled discharged from the second impeller 1B is discharged to the outside through the flow path 129 and the outlet 22a.

In the embodiment shown in FIG. 28, the first impeller 1A and the second impeller 1B are supported not only by the bearing 5 but also by the discharge side bearing 128. The discharge side bearing 128 is a radial bearing. With such a structure, the motor pump MP can suppress displacement of the first impeller 1A and the second impeller 1B in the radial direction.

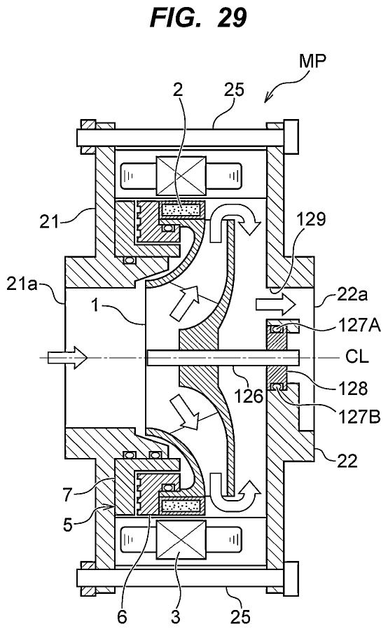

FIG. 29 is a view showing another embodiment of the motor pump. As shown in FIG. 29, the motor pump MP may include a communication shaft 126 to which one impeller 1 is fixed, and the discharge side bearing 128 that rotatably supports the communication shaft 126.

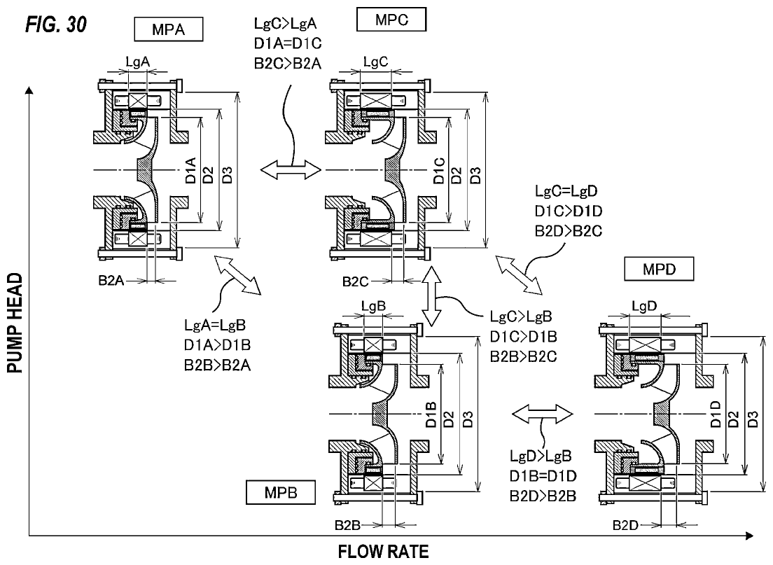

FIG. 30 is a view showing a motor pump in which various components can be selected depending on operating conditions. In FIG. 30, a horizontal axis shows a flow rate, and a vertical axis shows a pump head. As shown in FIG. 30, the motor pump MP is configured to be able to select optimal components according to various operating conditions (i.e., a magnitude of the flow rate and a magnitude of the pump head).

In the embodiment shown in FIG. 30, the motor pump MP can be selected from a plurality (four in this embodiment) of different components (i.e., configurations) depending on the magnitude of the pump head and the magnitude of the flow rate (see MPA to MPA in FIG. 30). In this embodiment, the motor pump MP includes a plurality of impellers 1 having different sizes, a plurality of rotors 2 fixed to the impellers 1 and having different lengths, a plurality of stator 3 having a length corresponding to the length of the rotors 2, and a plurality of stator casings 20 that accommodate the stators 3 and have a length corresponding to the length of the stators 3.

A size of a motor capacity of the motor pump MP depends on a length of a length Lg of the stator 3. The size of the pump head of the motor pump MP depends on a size of a diameter D1 of the impeller 1. The magnitude of the flow rate of the motor pump MP depends on the size of an outlet flow path B2 of the impeller 1.

The impellers 1 include the main plates 10 having different diameters from the side plates 11 having the same diameter. In this specification, the diameter DI of the impeller 1 corresponds to a diameter of the main plate 10.

A relationship between a motor pump MPA and a motor pump MPB will be described. As shown in FIG. 30, the motor pump MPA and the motor pump MPB have the same motor capacity (i.e., LgA=LgB). The motor pump MPA has a higher pump head capacity than that of the motor pump MPB (i.e., D1A>D1B). The motor pump MPB has a higher flow rate capacity than that of the motor pump MPA (i.e., B2B>B2A).

A relationship between the motor pump MPA and the motor pump MPC will be described. The motor pump MPC has a larger motor capacity than that of the motor pump MPA (i.e., LgC>LgA). The motor pump MPC has the same pump head capacity as that of the motor pump MPA (i.e., D1A=D1C). The motor pump MPC has a higher flow rate capacity than that of the motor pump MPA (i.e., B2C>B2A).

A relationship between the motor pump MPB and the motor pump MPC will be described. The motor pump MPC has a larger motor capacity than that of the motor pump MPB (i.e., LgC>LgB). The motor pump MPC has a higher pump head capacity than that of the motor pump MPB (i.e., D1C>D1B). An outlet flow path B2B of the impeller 1 of the motor pump MPB has the same size as that of an outlet flow path B2C of the impeller 1 of the motor pump MPC, or has a larger size than that of the outlet flow path B2C (i.e., B2B≥B2C).

A relationship between the motor pump MPC and the motor pump MPD will be described. The motor pump MPC has the same motor capacity as that of the motor pump MPD (i.e., LgC=LgD). The motor pump MPC has a higher pump head capacity than that of the motor pump MPD (i.e., D1C>D1D). The motor pump MPD has a higher flow rate capacity than that of the motor pump MPC (i.e., B2D>B2C).

A relationship between the motor pump MPB and the motor pump MPD will be described. The motor pump MPD has a larger motor capacity than that of the motor pump MPB (i.e., LgD>LgB). The motor pump MPD has a higher flow rate capacity than that of the motor pump MPB (i.e., B2D>B2B). The motor pump MPB has the same pump head capacity as that of the motor pump MPD (i.e., D1B=D1D).

As shown in FIG. 30, an inner diameter D2 and an outer diameter D3 of the stator casing 20 are the same in all motor pumps MP. Therefore, the operator may prepare components having different sizes depending on the pump head capacity and the flow rate capacity, and select the optimal component from the components based on the operating conditions of the motor pump MP.

By making the inner diameter D2 and the outer diameter D3 of the stator casing 20 the same, the pump unit PU can easily change its performance without changing the size of the components (e.g., the bearing 5, the suction casing 21, and the discharge casing 22) that are not dependent on the pump head or the flow rate capacity.

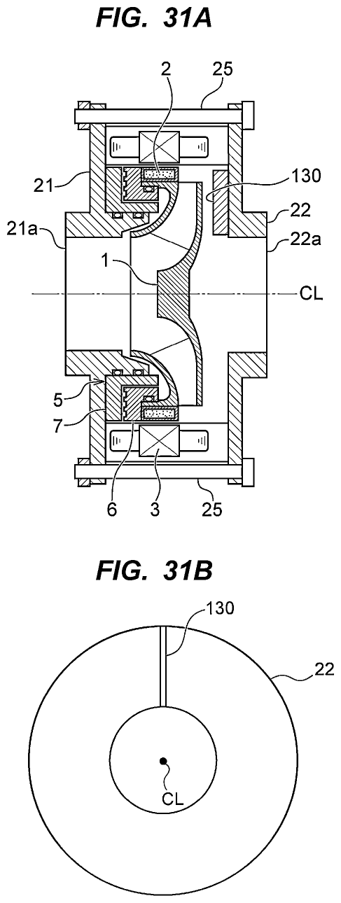

FIG. 31A is a sectional view of a motor pump according to another embodiment, and FIG. 31B is a view of the motor pump shown in FIG. 31A viewed from an axial direction. As shown in FIGS. 31A and 31B, the motor pump MP may include a swiveling stopper (in other words, whirl stopper) 130 arranged on the back side of the impeller 1.

In the embodiment shown in FIG. 31B, one swiveling stopper 130 is arranged, but at least one swiveling stopper 130 may be arranged. The swiveling stopper 130 is fixed to the discharge casing 22, and faces the main plate 10 of the impeller 1. The swiveling stopper 130 can prevent the liquid to be handled discharged from the impeller 1 from swiveling between the impeller 1 and the discharge casing 22.

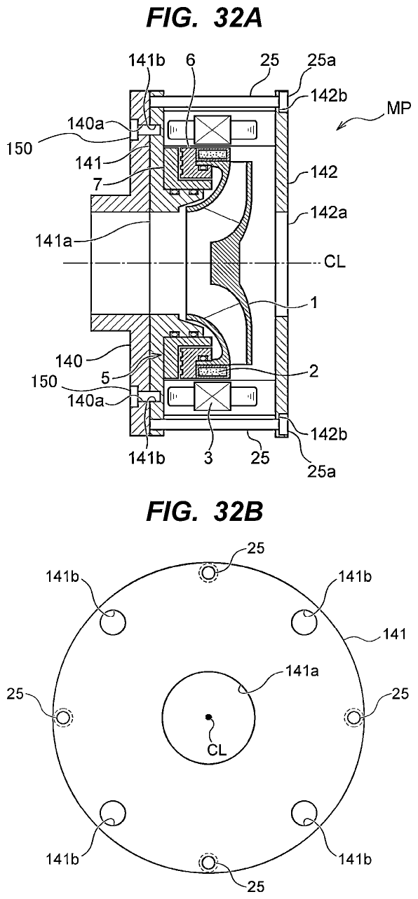

FIG. 32A is a cross sectional view of a motor pump according to another embodiment, and FIG. 32B is a front view of a suction casing of the motor pump shown in FIG. 32A. As shown in FIGS. 32A and 32B, the motor pump MP includes a suction casing 141 and a discharge casing 142 having a flat flange shape.

In the embodiment described above, the inlet 21a of the suction casing 21 protrudes from the outer surface of the suction casing 21, and similarly, the outlet 22a of the discharge casing 22 protrudes from the outer surface of the discharge casing 22. In this embodiment, since the suction casing 141 has the flat flange shape, an inlet 141a is formed on the same plane as the outer surface of the suction casing 141. Similarly, since the discharge casing 142 has a flat flange shape, an outlet 142a is formed on the same plane as the outer surface of the discharge casing 142.

With such a structure, a connection pipe 140 connected to the motor pump MP can be directly connected to the suction casing 141. Although not shown, the connection pipe 140 may be directly connected to the discharge casing 142 having a flat flange shape.

With such a configuration, there is no need to arrange a member (connection member) that connects the connection pipe 140 and the suction casing 141, and the number of parts for connecting a pipe (not shown) to the motor pump MP can be reduced.

Since the connection member is a member that is expected to leak liquid, by eliminating the connection member, it is possible to reliably prevent liquid leakage. In this embodiment, although not shown, a seal member (e.g., an O ring or a gasket) is arranged between the connection pipe 140 and the suction casing 141.

An insertion hole 141b into which a fastener 150 for fastening the connection pipe 140 and the suction casing 141 is inserted is formed radially outward from the inlet 141a of the suction casing 141. The connection pipe 140 has a through hole 140a that communicates with the insertion hole 141b. The operator can fasten the connection pipe 140 and the suction casing 141 to each other by inserting the fastener 150 into the through hole 140a and the insertion hole 141b.

A bolt accommodating portion 142b for accommodating a head portion 25a of the through bolt 25 is formed radially outward from the outlet 142a of the discharge casing 142. By accommodating the head portion 25a of the through bolt 25 in the bolt accommodating portion 142b, it is possible to prevent the head portion 25a from protruding from the discharge casing 22.

In one embodiment, the suction casing 141 may have a bolt accommodating portion corresponding to the bolt accommodating portion 142b. That is, at least one of the suction casing 141 and the discharge casing 142 has a bolt accommodating portion that accommodates the head portion 25a of the through bolt 25.

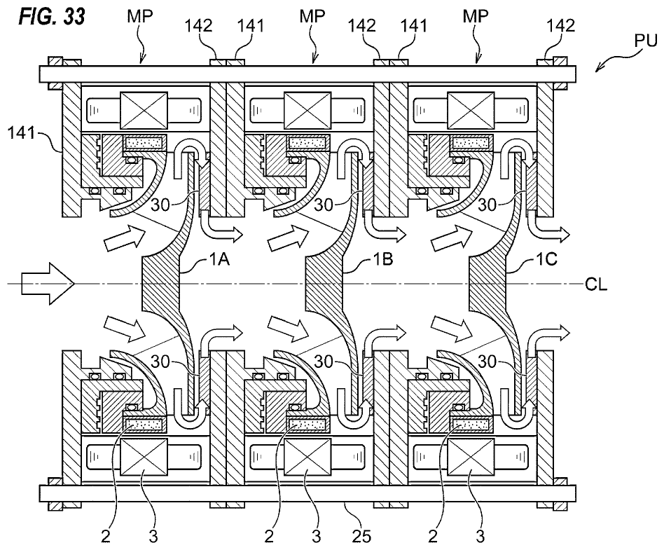

FIG. 33 is a view showing a pump unit including motor pumps connected in series. As shown in FIG. 33, the motor pump MP shown in FIGS. 32A and 32B includes the suction casing 141 and the discharge casing 142 having a flat flange shape. The suction casing 141 and the discharge casing 142 arranged adjacent to each other can be in surface contact with each other. The suction casing 141 and the discharge casing 142 in surface contact with each other correspond to intermediate casings.

Although not shown, a seal member (e.g., an O ring or a gasket) is arranged between the suction casing 141 and the discharge casing 142 that are in surface contact with each other.

According to this embodiment, there is no need to arrange the intermediate casing 61 (see FIG. 10), and by simple operating of directly connecting the motor pumps MP having the same structure in series, the pump unit PU including the motor pumps MP can be configured.

The motor pump MP according to the embodiment includes simple main components (i.e., the impeller 1, the rotor 2 and the stator 3, and the bearing 5), and is made smaller and lighter. Therefore, by using the through bolt 25, the motor pumps MP arranged in series can be easily fastened together.

Furthermore, by bringing the suction casing 141 and the discharge casing 142 into surface contact with each other, a thermal conductivity of the pump unit PU can be improved, and a temperature balance can be achieved between the motor pumps MP. As a result, the pump unit PU can be stably operated.

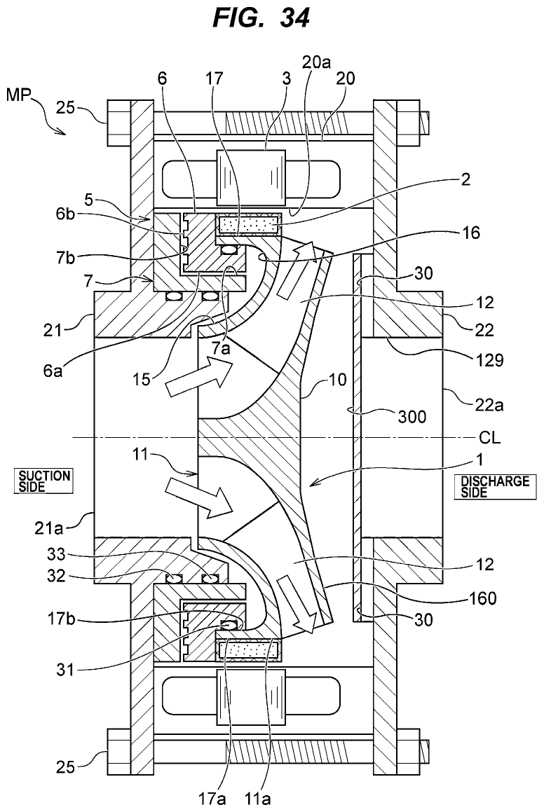

FIG. 34 is a view showing another embodiment of the impeller. In the embodiment described above, the impeller 1 is a centrifugal impeller. More specifically, the impeller 1 includes the main plate 10 extending perpendicularly to the direction of the center line CL, and the liquid pressurized by the impeller 1 is discharged perpendicularly to the center line CL. In the embodiment shown in FIG. 34, the impeller 1 is a mixed flow impeller. More specifically, the impeller 1 includes a main plate 160 that is inclined at a predetermined angle with respect to the direction of the center line CL. The main plate 160 is inclined from the suction side to the discharge side, and the liquid pressurized by the impeller 1 is discharged diagonally outward with respect to the center line CL.

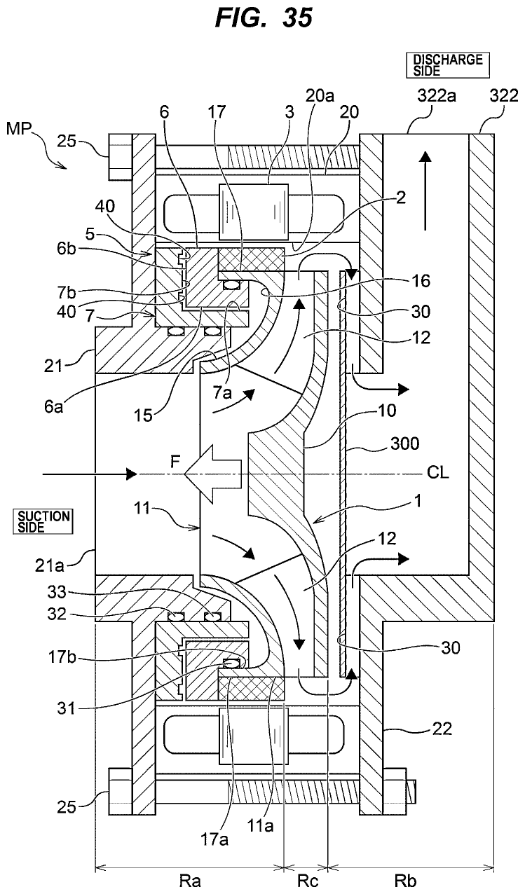

FIG. 35 is a view showing another embodiment of the motor pump. In the embodiment shown in FIG. 35, the motor pump MP includes the discharge casing 22 having a discharge port 322 extending in a vertical direction perpendicular to the direction of the center line CL of the motor pump MP. The discharge port 322 has an outlet 322a that opens upward, and the inlet 21a and the outlet 322a are orthogonal to each other.

In the embodiment shown in FIG. 35, the motor pump MP is a so-called end-top type motor pump in which the inlet 21a and the outlet 322a are orthogonal to each other. Such a motor pump MP has a compact structure. For example, depending on an installation environment of the motor pump MP, it may not be possible to install the motor pump MP having a structure in which the inlet 21a and the outlet 22a are arranged in a straight line. Even in such a case, the end-top type motor pump MP can be installed. In this manner, in this embodiment, the motor pump MP can be installed corresponding to any installation environment.

As shown in FIG. 35, the motor pump MP may further include a side plate 300 that restricts an outflow of the liquid (liquid to be handled) pressurized by the impeller 1 to the discharge port 322. In the embodiment shown in FIG. 35, the side plate 300 has a disc shape and is fixed to the return vane 30.

The side plate 300 is arranged between the main plate 10 of the impeller 1 and the return vane 30. A part of the liquid pressurized by the impeller 1 flows through the gap between the side plate 300 and the discharge casing 22 via the return vane 30, flows into the discharge port 322, and is discharged from the outlet 322a. The other part of the liquid pressurized by the impeller 1 flows into the gap between the side plate 300 and the main plate 10 of the impeller 1.

When the impeller 1 rotates, a force of the liquid (i.e., force of fluid) that pushes the impeller 1 toward the discharge casing 22 acts on the impeller 1. Since a flow of the liquid that has flowed into the gap between the side plate 300 and the main plate 10 is restricted by the side plate 300, the pressurized liquid remains in the gap between the side plate 300 and the main plate 10. Since the liquid remaining in the gap between the side plate 300 and the main plate 10 receives the force of the fluid acting on the impeller 1, a movement of the impeller 1 toward the discharge casing 22 is restricted.

When the motor pump MP is operated steadily, a thrust force acts on the impeller 1 from the discharge casing 22 side to the suction casing 21 side. Therefore, even if the force of the fluid acts on the impeller 1, the impeller 1 is stably held by the bearing 5.

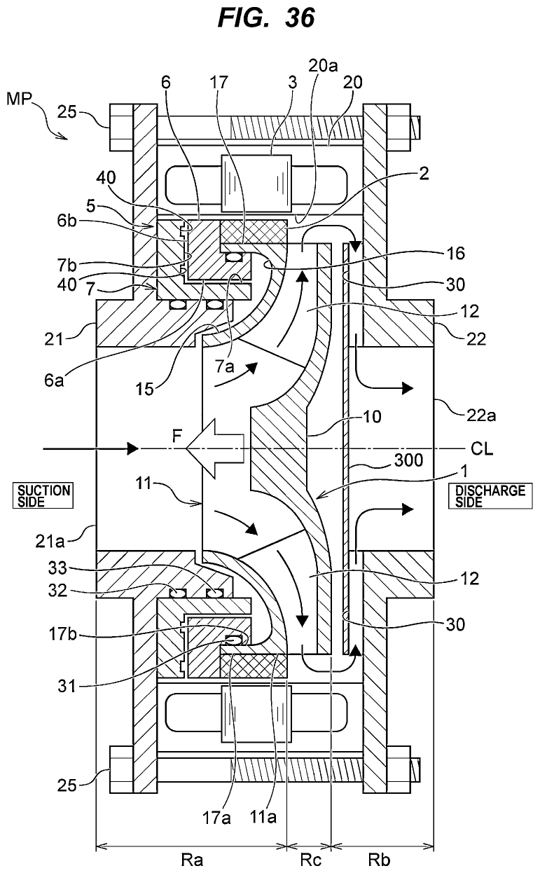

FIG. 36 is a view showing the side plate provided in the motor pump according to the embodiment described above. As shown in FIG. 36, the side plate 300 is applicable not only to the end-top type motor pump but also to the motor pump MP according to the embodiment described above.

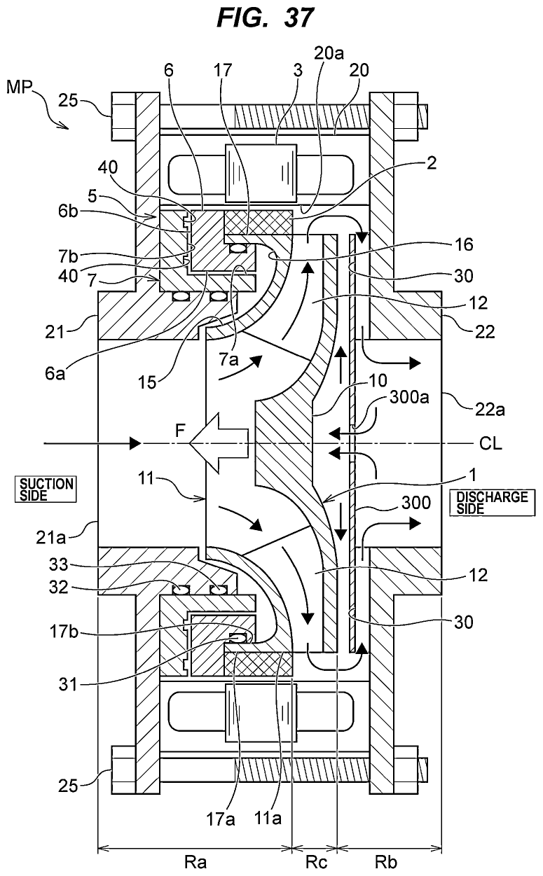

FIG. 37 is a view showing another embodiment of the side plate. As shown in FIG. 37, the side plate 300 may have an opening 300a formed in the center thereof. As described above, the liquid that has flowed into the gap between the side plate 300 and the main plate 10 may remain in the gap between the side plate 300 and the main plate 10.

In this case, by rotating the impeller 1, the remaining liquid may swirl and eventually generate heat. By forming the opening 300a in the side plate 300, a circulating flow of the liquid is formed between the gap between the side plate 300 and the discharge casing 22 and the gap between the side plate 300 and the impeller 1. Therefore, the liquid existing between the side plate 300 and the impeller 1 flows into the discharge casing 22 side, and a heat generation in the liquid is prevented and the temperature of the liquid is maintained at a constant level. Furthermore, the opening 300a can serve to discharge air contained in the remaining liquid to the discharge casing 22 side.

In the embodiment shown in FIG. 37, the opening 300a of the side plate 300 is a single opening formed on the center line CL, but the number of openings 300a is not limited to this embodiment. The side plate 300 may have a plurality of openings 300a to an extent that the movement of the impeller 1 toward the discharge casing 22 is restricted.

Furthermore, the opening 300a does not necessarily need to be formed on the center line CL as long as it can form the circulating flow of the liquid. For example, the side plate 300 may have at least one opening 300a arranged concentrically around the center line CL.

The shape of the opening 300a is also not particularly limited, and may have a circular shape or a polygonal shape (e.g., a triangular shape or a quadrangular shape). Similarly, a size (i.e., area) of the opening 300a is not particularly limited as long as the movement of the side plate 300 toward the discharge casing 22 is restricted.

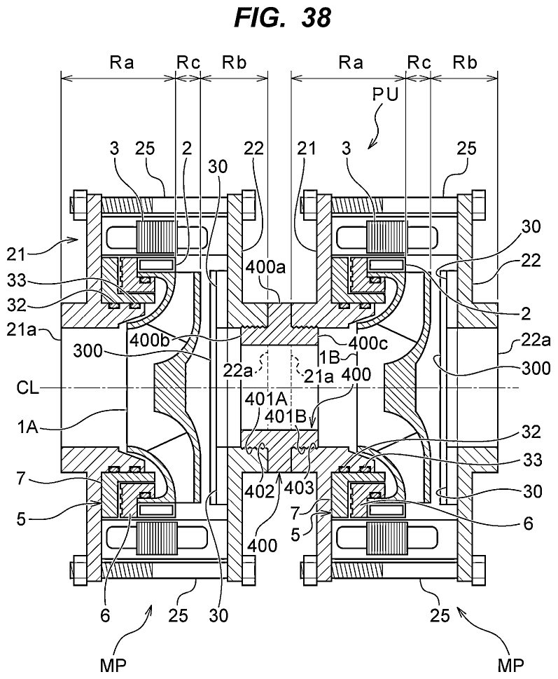

FIG. 38 is a view showing another embodiment of the pump unit. As shown in FIG. 38, the pump unit PU may include a plurality of motor pumps MP arranged in series, and a connector 400 that connects the motor pumps MP. In the embodiment shown in FIG. 38, each of the motor pumps MP has the same structure as that shown in the embodiment described above. Therefore, a detailed explanation of the motor pump MP will be omitted.

In the embodiment shown in FIG. 38, the pump unit PU includes two motor pumps MP (i.e., a front-stage side motor pump MP and a rear-stage side motor pump MP), but the number of motor pumps MP is not limited that in this embodiment.

The connector 400 is a connection member that connects a front-stage side discharge casing 22 of the front-stage side motor pump MP and a rear-stage side suction casing 21 of the rear-stage side motor pump MP. The connector 400 has an overall cylindrical shape. More specifically, the connector 400 includes a flange portion 400a arranged between the front-stage side discharge casing 22 and the rear-stage side suction casing 21, and a front-stage side connection portion 400b extending from the flange portion 400a to the front-stage side discharge casing 22, and a rear-stage side connection portion 400c extending from the flange portion 400a to the rear-stage side suction casing 21.

In this embodiment, each of the front-stage side connection portion 400b and the rear-stage side connection portion 400c has a cylindrical shape. In one embodiment, each of the front-stage side connecting portion 400b and the rear-stage side connection portion 400c may have a polygonal cylindrical shape. The front-stage side connection portion 400b is attached to the front-stage side discharge casing 22, and the rear-stage side connection portion 400c is attached to the rear-stage side suction casing 21. More specifically, the front-stage side connection portion 400b is inserted into the outlet 22a of the front-stage side discharge casing 22, and the rear-stage side connection portion 400c is inserted into the inlet 21a of the rear-stage side suction casing 21.

The connector 400 has a screw-in structure that is screwed into the front-stage side motor pump MP and the rear-stage side motor pump MP. The front-stage side connection portion 400b has a male threaded portion 401A formed on its outer surface, and the front-stage side discharge casing 22 has a female threaded portion 402 corresponding to the male threaded portion 401A. Similarly, the rear-stage side connection portion 400c has a male threaded portion 401B formed on its outer surface, and the rear-stage side suction casing 21 has a female threaded portion 403 corresponding to the male threaded portion 401B. By screwing the connector 400 into the front-stage side discharge casing 22 and the rear-stage side suction casing 21, the front-stage side motor pump MP and the rear-stage side motor pump MP are fluid-tightly connected to each other via the connector 400.

According to this embodiment, the pump unit PU has a connector 400 that connects the motor pumps MP having a compact structure to each other. Since the connector 400 has a simple structure, there is no need to connect the motor pumps MP with each other using a complicated structure. By connecting the motor pumps MP with the connector 400 having a simple structure, the pump unit PU can have a compact structure.

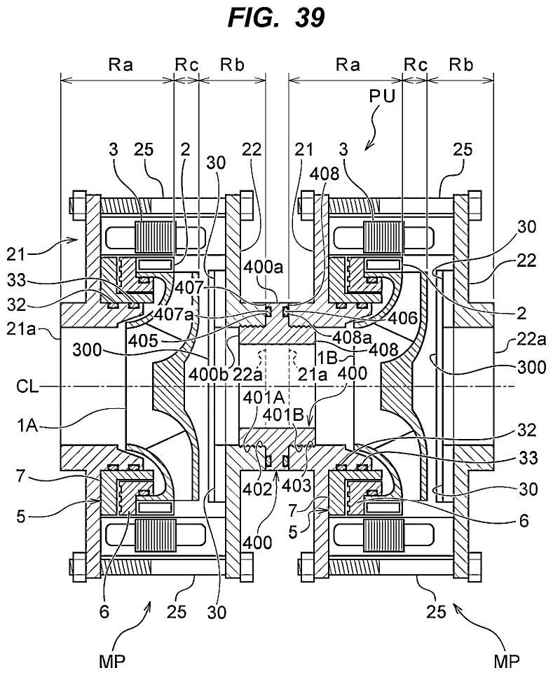

FIG. 39 is a view showing a seal member attached to the connector. As shown in FIG. 39, the connector 400 includes a first seal member 405 that is in close contact with the front-stage side discharge casing 22 and a second seal member 406 that is in close contact with the rear-stage side suction casing 21. More specifically, the flange portion 400a of the connector 400 has a first adjacent surface 407 adjacent to the front-stage side discharge casing 22 and a second adjacent surface 408 adjacent to the rear-stage side suction casing 21.

The flange portion 400a has a first annular seal groove 407a formed in the first adjacent surface 407, and the first seal member 405 is attached in the first annular seal groove 407a. Similarly, the flange portion 400a has a second annular seal groove 408a formed in the second adjacent surface 408, and the second seal member 406 is attached in the second annular seal groove 408a. With such a configuration, leakage of liquid from the connector 400 can be more reliably prevented. Also in this embodiment, the connector 400 may have a screw-in structure.

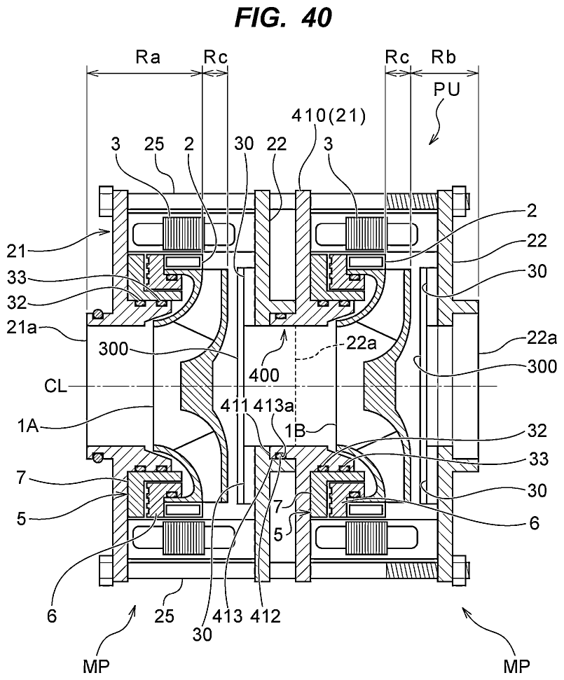

FIG. 40 is a view showing another embodiment of the pump unit. As shown in FIG. 40, the connector 400 may include a suction casing connector 410 configured integrally with the rear-stage side suction casing 21. In other words, the rear-stage side motor pump MP includes a suction casing connector 410 in which the connector 400 and the rear-stage side suction casing 21 are integrally configured.

The suction casing connector 410 includes a cylindrical attachment portion 413 that is attached to the front-stage side discharge casing 22. The cylindrical attachment portion 413 is inserted into the outlet 22a of the front-stage side discharge casing 22. The suction casing connector 410 has a seal member 412 attached to an outer surface of the cylindrical attachment portion 413. The cylindrical attachment portion 413 has an annular seal groove 413a formed on its outer surface, and the seal member 412 is attached to the annular seal groove 413a. With such a configuration, leakage of liquid from the suction casing connector 410 can be more reliably prevented.

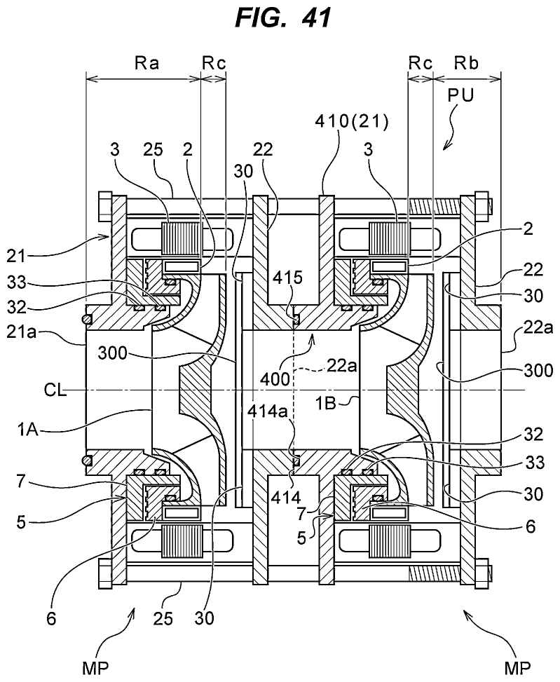

FIG. 41 is a view showing another embodiment of the suction casing connector. In the embodiment shown in FIG. 41, the cylindrical attachment portion 413 is not inserted into the outlet 22a of the front-stage side discharge casing 22. As shown in FIG. 41, the suction casing connector 410 has an end surface 414 formed in the cylindrical attachment portion 413. The suction casing connector 410 includes a seal member 415 attached to the end surface 414 of the cylindrical attachment portion 413, and the seal member 415 is attached to an annular seal groove 414a formed in the end surface 414. By arranging the seal member 415 between the suction casing connector 410 and the front-stage side discharge casing 22, leakage of liquid from the suction casing connector 410 can be more reliably prevented.

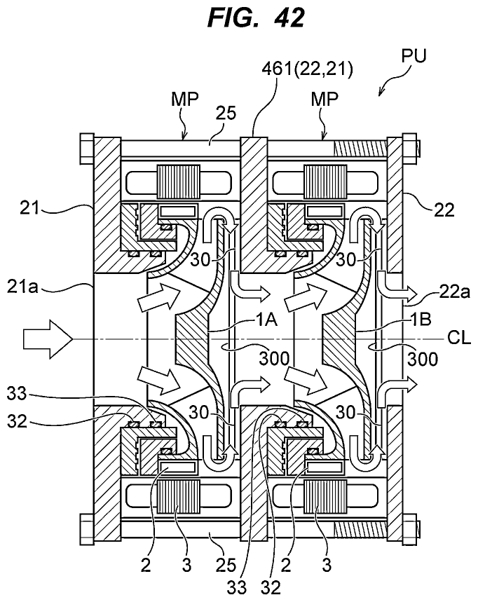

FIG. 42 is a view showing another embodiment of the pump unit. In the embodiment shown in FIG. 42, the connector 400 includes an intermediate casing connector 461 that integrally constitutes the front-stage side discharge casing 22 and the rear-stage side suction casing 21. The intermediate casing connector 461 has the same configuration as the intermediate casing 61 shown in FIG. 10.

With the intermediate casing connector 461 sandwiched between the suction casing 21 and the discharge casing 22, the operator inserts the through bolt 25 into the suction casing 21, the intermediate casing connector 461, and the discharge casing 22, and tightens them. In this manner, the pump unit PU can be assembled.

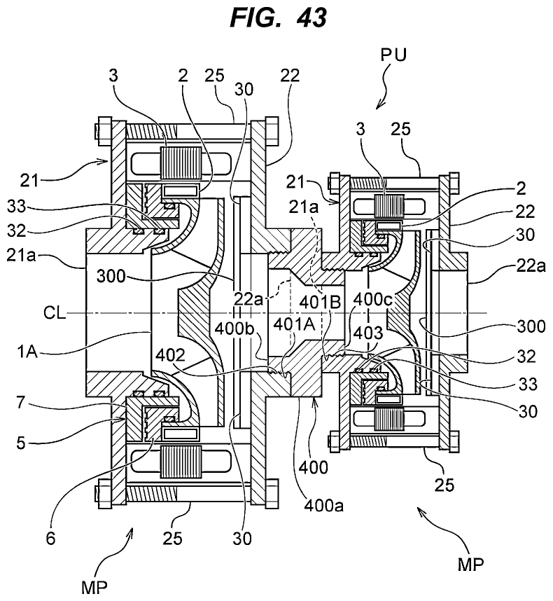

FIG. 43 is a view showing another embodiment of the pump unit. In the embodiment shown in FIG. 43, the front-stage side discharge casing 22 has the outlet 22a having a first diameter, and the rear-stage side suction casing 21 has the inlet 21a having a second diameter different from the first diameter. More specifically, a diameter of the inlet 21a is smaller than a diameter of the outlet 22a. In one embodiment, the diameter of the inlet 21a may be larger than the diameter of the outlet 22a.

In the embodiment shown in FIG. 43, the impeller 1A of the front-stage side motor pump MP has a larger size than the impeller 1B of the rear-stage side motor pump MP. The front-stage side motor pump MP is a low speed motor pump that is driven at low speed, and the rear-stage side motor pump MP is a high speed motor pump that is driven at high speed.

The connector 400 includes a front-stage side connection portion 400b connected to the outlet 22a of the front-stage side discharge casing 22, and a rear-stage side connection portion 400c connected to the inlet 21a of the rear-stage side suction casing 21. The front-stage side connection portion 400b and the rear-stage side connection portion 400c extend on both sides of the flange portion 400a.

As shown in FIG. 43, the rear-stage side connection portion 400c has a different size (diameter) from the front-stage side connection portion 400b. The size of the rear-stage side connection portion 400c is smaller than the size of the front-stage side connection portion 400b, and corresponds to the size of the inlet 21a of the rear-stage side suction casing 21. Similarly, the size of the front-stage side connection portion 400b corresponds to the size of the outlet 22a of the front-stage side discharge casing 22.

The front-stage side connection portion 400b has the male threaded portion 401A formed on its outer surface, and the front-stage side discharge casing 22 has the female threaded portion 402 corresponding to the male threaded portion 401A. Similarly, the rear-stage side connection portion 400c has a male threaded portion 401B formed on its outer surface, and the rear-stage side suction casing 21 has the female threaded portion 403 corresponding to the male threaded portion 401B.

By screwing the connector 400 into the front-stage side discharge casing 22 and the rear-stage side suction casing 21, the front-stage side motor pump MP and the rear-stage side motor pump MP are fluid-tightly connected to each other via the connector 400. In this embodiment, the connector 400 can couple the motor pumps MP of different sizes.

In the embodiment shown in FIG. 43, the size of the front-stage side discharge casing 22 and the size of the rear-stage side suction casing 21 are different. Therefore, the suction casing 21 and the discharge casing 22 of the front-stage side motor pump MP are fastened together with the through bolt 25, and the suction casing 21 and the discharge casing 22 of the rear-stage side motor pump MP are fastened together with the through bolt 25.

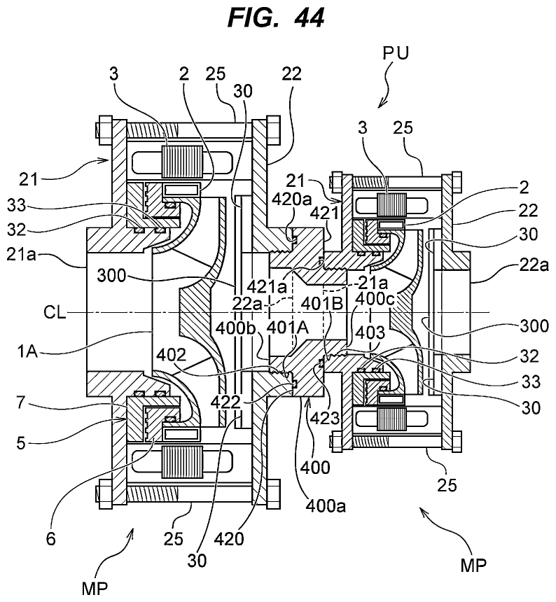

FIG. 44 is a view showing a seal member attached to the connector. As shown in FIG. 44, the connector 400 includes a first seal member 422 that is in close contact with the front-stage side discharge casing 22, and a second seal member 423 that is in close contact with the rear-stage side suction casing 21. More specifically, the flange portion 400a of the connector 400 has a first adjacent surface 420 adjacent to the front-stage side discharge casing 22 and a second adjacent surface 421 adjacent to the rear-stage side suction casing 21.

The flange portion 400a has a first annular seal groove 420a formed in the first adjacent surface 420, and the first seal member 422 is attached to the first annular seal groove 420a. Similarly, the flange portion 400a has a second annular seal groove 421a formed in the second adjacent surface 421, and the second seal member 423 is attached to the second annular seal groove 421a. With such a configuration, leakage of liquid from the connector 400 can be more reliably prevented.

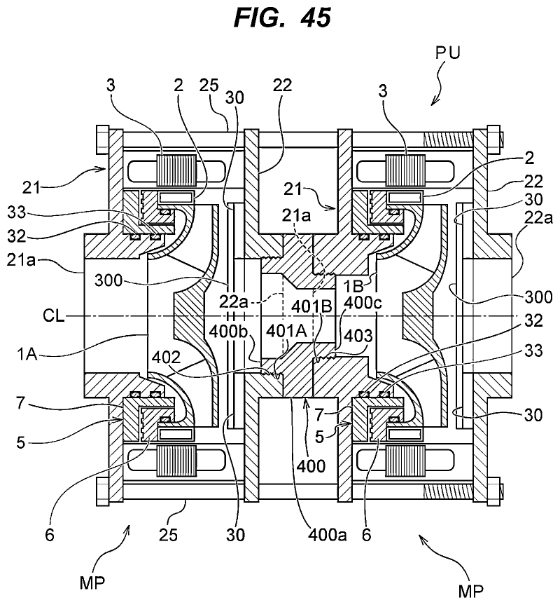

FIG. 45 is a view showing another embodiment of the pump unit. As shown in FIG. 45, the size of the front-stage side discharge casing 22 and the size of the rear-stage side suction casing 21 may be the same. In this case, the suction casing 21 and the discharge casing 22 of the front-stage side motor pump MP and the suction casing 21 and the discharge casing 22 of the rear-stage side stage motor pump MP are fastened with the same through bolt 25.

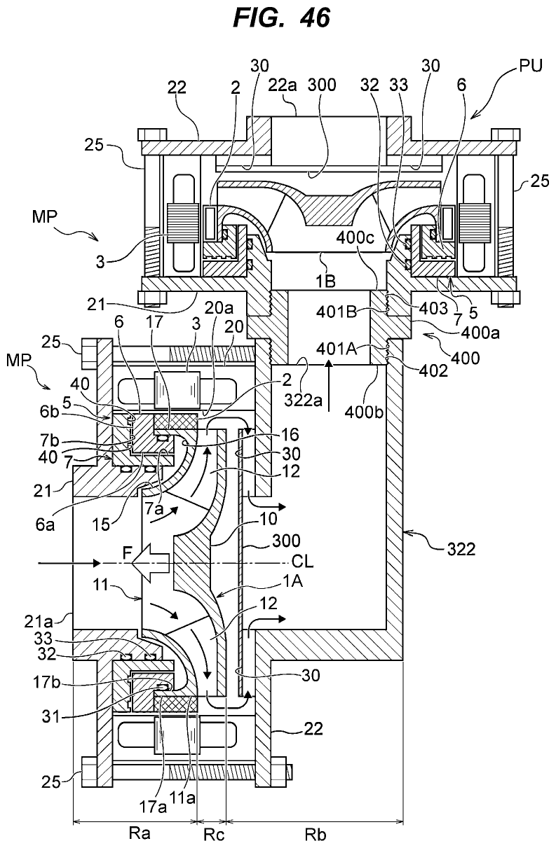

FIG. 46 is a view showing another embodiment of the pump unit. As shown in FIG. 46, the embodiment shown in FIG. 35 and the embodiment shown in FIG. 38 may be combined. More specifically, the front-stage side discharge casing 22 of the front-stage side motor pump MP has the discharge port 322 extending in a direction perpendicular to the direction of the center line CL, and the connector 400 connects the discharge port 322 and the rear-stage side discharge casing 22 of the rear-stage side motor pump MP.

Although not shown, the connector 400 may include a first seal member that is in close contact with the discharge port 322, and a second seal member that is in close contact with the rear-stage side suction casing 21 (see FIG. 39).

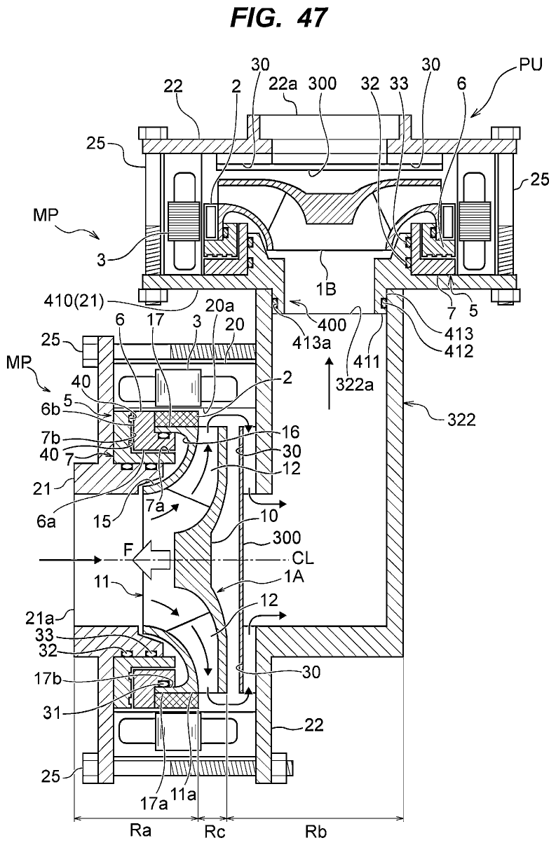

FIG. 47 is a view showing another embodiment of the pump unit. As shown in FIG. 47, the embodiment shown in FIG. 35 and the embodiment shown in FIG. 40 may be combined. More specifically, the front-stage side discharge casing 22 of the front-stage side motor pump MP has the discharge port 322 extending in a direction perpendicular to the direction of the center line CL, and the connector 400 includes the suction casing connector 410 configured integrally with the rear-stage side suction casing 21, and the suction casing connector 410 includes the cylindrical attachment portion 413 that is attached to the discharge port 322.

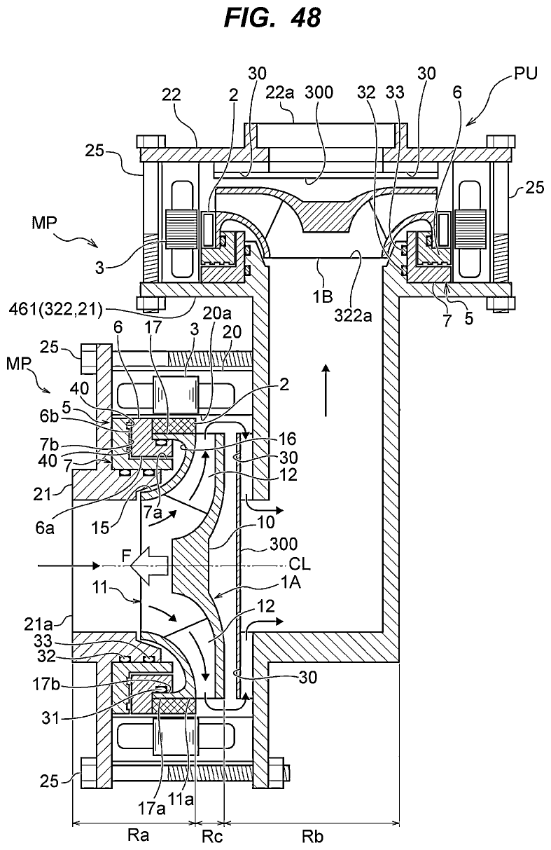

FIG. 48 is a view showing another embodiment of the pump unit. As shown in FIG. 48, the embodiment shown in FIG. 35 and the embodiment shown in FIG. 42 may be combined. More specifically, the connector 400 includes an intermediate casing connector 461 that integrally configures the discharge port 322 and the rear-stage side suction casing 21.

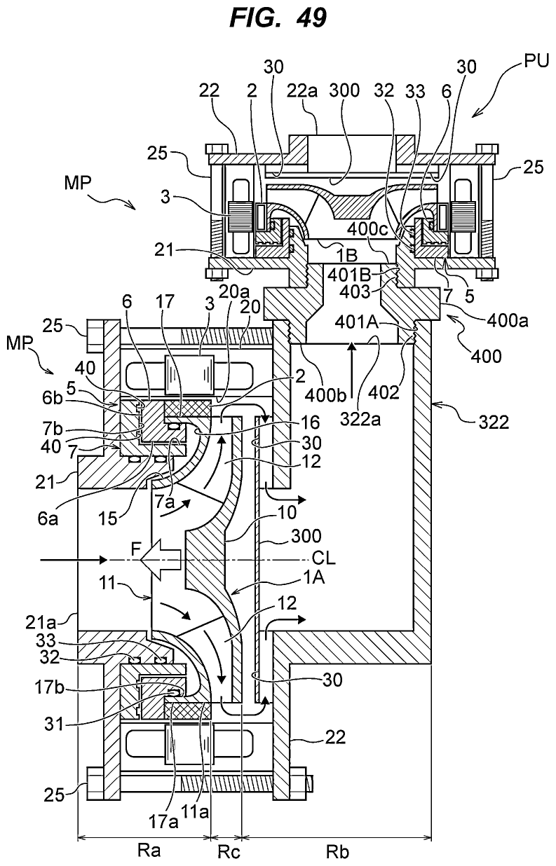

FIG. 49 is a view showing another embodiment of the pump unit. As shown in FIG. 49, the embodiment shown in FIG. 35 and the embodiment shown in FIG. 43 may be combined. More specifically, the discharge port 322 has the outlet 322a having a first diameter, and the rear-stage side suction casing 21 has the inlet 21a having a second diameter different from the first diameter. In the embodiment shown in FIG. 49, the outlet 322a has a larger size than that of the inlet 21a. In one embodiment, the outlet 322a may have a smaller size than that of the inlet 21a.

The connector 400 includes the first-stage side connection portion 400b connected to the outlet 322a, and the rear-stage side connection portion 400c connected to the suction port 21a and having a different size from the front-stage side connection portion 400b.

The above embodiments are described for the purpose of practicing the present invention by a person with ordinary skill in the art to which the invention pertains. Although preferred embodiments have been described in detail above, it should be understood that the present invention is not limited to the illustrated embodiments, but many changes and modifications can be made therein without departing from the appended claims.

### Industrial Applicability

The invention is applicable to a pump unit.

### REFERENCE SIGNS LIST

1, 1A, 1B, 1C impeller
2 rotor
2a iron core
2b magnet
3 stator
5 bearing
6 rotary side bearing body
6a cylindrical portion
6b flange portion
7 stationary side bearing body
7a cylindrical portion
7b flange portion
10 main plate
10a through hole
11 side plate
11a outer edge portion
12 vane
15 suction portion
16 body portion
17 protrusion
17a outer circumferential surface
17b inner circumferential surface
20 stator casing
20a inner circumferential surface
21 suction casing
21a inlet
22 discharge casing
22a outlet
25 through bolt
25a head portion
30 return vane
31 seal member
32, 33 seal member
40, 41, 42 groove
41a both ends
45 thrust load reduction structure
46 back vane
47 notch
50, 51 inclined surface
53, 54 inclined surface
60 inverter
61 intermediate casing
65 pipe
70, 70A, 70B convex portion
71 tip potion
75 balancing jig (center support adjustment jig)
76 shaft body
77 fixed body
80 center cap
85 balancing jig (edge support adjustment jig)
86 supporter
87 shaft portion
90 weight insertion hole
91 weight
100 control device
100a signal receiver
100b memory
100c controller
101 current sensor
102 terminal block
105 power line
106 signal line
107 protective cover
108 copper bar
110 cover
117 protrusion
118 mounting portion
120 seal member
121 seal member
125 intermediate casing
126 communication shaft
127A seal member
127B seal member
128 discharge side bearing
129 flow path
130 swiveling stopper
140 connection pipe
141 suction casing
141a inlet
141b insertion hole
142 discharge casing
142a outlet
142b bolt accommodating portion
150 fastener
160 main plate
300 side plate
300a opening
322 discharge port
322a outlet
400 connector
400a flange portion
400b front-stage side connection portion
400c rear-stage side connection portion
401A male threaded portion
401B male threaded portion
402 female threaded portion
403 female threaded portion
405 first seal member
406 second seal member
407 first adjacent surface
407a first annular seal groove
408 second adjacent surface
408a second annular seal groove
410 suction casing connector
412 seal member
413 cylindrical attachment portion
413a annular seal groove
414 end surface
414a annular seal groove
415 seal member
420 first adjacent surface
420a first annular seal groove
421 second adjacent surface
421a second annular seal groove
422 first seal member
423 second seal member
461 intermediate casing connector
MP motor pump
PU pump unit
CL center line
Ra suction side region
Rb discharge side region
Rc intermediate region
RS rotary shaft
Nt nut

1. A pump unit, comprising:
a plurality of motor pumps comprising a front-stage side motor pump and a rear-stage side motor pump; and
a connector configured to connect the motor pumps,
wherein each of the motor pumps comprises:
an impeller;
a rotor fixed to the impeller;
a stator arranged radially outward of the rotor; and
a bearing configured to support the impeller,
wherein the rotor and the bearing are arranged in a suction side region of the impeller, and
wherein the connector is configured to connect a front-stage side discharge casing of the front-stage side motor pump and a rear-stage side suction casing of the rear-stage side motor pump.

2. The pump unit according to claim 1, wherein the connector comprises:
a first seal member configured to be in close contact with the front-stage side discharge casing; and
a second seal member configured to be in close contact with the rear-stage side suction casing.

3. A pump unit, comprising:
a plurality of motor pumps comprising a front-stage side motor pump and a rear-stage side motor pump; and
a connector configured to connect the motor pumps,
wherein each of the motor pumps comprises:
an impeller;
a rotor fixed to the impeller;
a stator arranged radially outward of the rotor; and
a bearing configured to support the impeller,
wherein the rotor and the bearing are arranged in a suction side region of the impeller,
wherein the connector is configured to connect a front-stage side discharge casing of the front-stage side motor pump and a rear-stage side suction casing of the rear-stage side motor pump,
wherein the connector comprises a suction casing connector integrally configured with the rear-stage side suction casing, and
wherein the suction casing connector comprises a cylindrical attachment portion that is inserted into or face-connected to an outlet of the front-stage side discharge casing.

4. The pump unit according to claim 3, wherein the suction casing connector comprises a seal member configured to be in close contact with the front-stage side discharge casing, and
wherein the seal member is attached to an outer surface of the cylindrical attachment portion.

5. The pump unit according to claim 3, wherein the suction casing connector comprises a seal member configured to be in close contact with the front-stage side discharge casing, and
wherein the seal member is attached to an end surface of the cylindrical attachment portion.

6. A pump unit, comprising:
a plurality of motor pumps comprising a front-stage side motor pump and a rear-stage side motor pump; and
a connector configured to connect the motor pumps,
wherein each of the motor pumps comprises:
an impeller;
a rotor fixed to the impeller;
a stator arranged radially outward of the rotor; and
a bearing configured to support the impeller,
wherein the rotor and the bearing are arranged in a suction side region of the impeller, and
wherein the connector comprises an intermediate casing connector that integrally configures a front-stage side discharge casing of the front-stage side motor pump and a rear-stage side suction casing of the rear-stage side motor pump.

7. A pump unit, comprising:
a plurality of motor pumps comprising a front-stage side motor pump and a rear-stage side motor pump; and
a connector configured to connect the motor pumps,
wherein each of the motor pumps comprises:
an impeller;
a rotor fixed to the impeller;
a stator arranged radially outward of the rotor; and
a bearing configured to support the impeller,
wherein the rotor and the bearing are arranged in a suction side region of the impeller,
wherein a front-stage side discharge casing of the front-stage side motor pump has an outlet having a first diameter,
wherein a rear-stage side suction casing of the rear-stage side motor pump has an inlet having a second diameter different from the first diameter, and
wherein the connector comprises:
a front-stage side connection portion connected to the outlet; and
a rear-stage side connection portion connected to the inlet and having a different size from that of the front-stage side connection portion.

8. The pump unit, according to claim 7, wherein the connector comprises:
a first seal member configured to be in close contact with the front-stage side discharge casing; and
a second seal member configured to be in close contact with the rear-stage side suction casing.

9. A pump unit, comprising:
a plurality of motor pumps comprising a front-stage side motor pump and a rear-stage side motor pump; and
a connector configured to connect the motor pumps,
wherein each of the motor pumps comprises:
an impeller;
a rotor fixed to the impeller;
a stator arranged radially outward of the rotor; and
a bearing configured to support the impeller,
wherein the rotor and the bearing are arranged in a suction side region of the impeller,
wherein a front-stage side discharge casing of the front-stage side motor pump has a discharge port extending in a direction of a center line of the front-stage side motor pump, and the discharge port having an outlet opening in a direction perpendicular to the direction of the center line, and
wherein the connector is configured to connect the discharge port and a rear-stage side suction casing of the rear-stage side motor pump.

10. The pump unit according to claim 9, wherein the connector comprises:
a first seal member configured to be in close contact with the discharge port; and
a second seal member configured to be in close contact with the rear-stage suction casing.

11. The pump unit according to claim 9, wherein the connector comprises a suction casing connector integrally configured with the rear-stage side suction casing, and
wherein the suction casing connector comprises a cylindrical attachment portion attached to the discharge port.

12. The pump unit according to claim 9, wherein the connector comprises an intermediate casing connector that integrally configures the discharge port and the rear-stage side suction casing.

13. The pump unit according to claim 9, wherein the discharge port has an outlet having a first diameter,
wherein the rear-stage side suction casing has an inlet having a second diameter different from the first diameter, and
wherein the connector comprises:
a front-stage side connection portion connected to the outlet; and
a rear-stage side connection portion connected to the inlet and having a different size from that of the front-stage side connection portion.
